(19) United States
(12) Patent Application Publication
(10) Pub. No.: US 2026/0051469 A1
(43) Pub. Date: Feb. 19, 2026

(54) Complex Equipment and Equipment Layout

(71) Applicant: SK On Co., Ltd., Seoul (KR)

(72) Inventor: Do Heon KIM, Daejeon (KR)

(21) Appl. No.: 19/271,849

(22) Filed: Jul. 17, 2025

(30) Foreign Application Priority Data
Aug. 16, 2024 (KR) 10-2024-0110065
Nov. 20, 2024 (KR) 10-2024-0166379

(51) Int. Cl. H01M 4/04; H01M 4/02

(52) U.S. Cl. CPC H01M 4/04; H01M 2004/027; H01M 2004/028

(57) ABSTRACT

Proposed are complex equipment and an equipment layout including the same. The complex equipment includes an electrode manufacturing machine for forming an electrode by creating a tab on an electrode sheet, and drying and cutting the sheet, first direction transporters for transporting the electrode output from the electrode manufacturing machine in the first direction, a first stacker and a second stacker located outside a positive electrode first direction transporter and a negative electrode first direction transporter, at least one positive electrode second direction transporter for transporting a positive electrode transported on the positive electrode first direction transporter in the second direction and supplying the positive electrode to the first and second stackers, and at least one negative electrode second direction transporter for transporting a negative electrode transported on the negative electrode first direction transporter in the second direction and supplying the negative electrode to the first and second stackers.

### CROSS REFERENCE TO RELATED APPLICATIONS

The present application claims priority to Korean Patent Application No. 10-2024-0110065, filed Aug. 16, 2024, and Korean Patent Application No. 10-2024-0166379, filed Nov. 20, 2024, the entire contents of which is incorporated herein for all purposes by this reference.

### TECHNICAL FIELD

The present disclosure relates to complex equipment and an equipment layout.

### BACKGROUND

Secondary batteries can be charged and discharged. Secondary batteries are used in electric vehicles, energy storage systems (ESS), portable electronic devices, etc. A secondary battery is formed by immersing an electrode assembly containing a negative electrode, a separator, and a positive electrode in an electrolyte and enclosing the electrode assembly in a casing. The process of creating an electrode assembly includes coating, drying, notching, and stacking. Coating involves applying an active material layer onto a current collector. Drying involves drying the active material layer coated on the current collector. Notching creates tabs by cutting the current collector of the negative or positive electrode. Stacking involves layering and joining the negative electrode, separator, and positive electrode to form the electrode assembly.

### SUMMARY

According to an aspect of the present disclosure, there is provided complex equipment that integrates drying equipment, notching equipment, and stacking equipment into one facility.

According to an aspect of the present disclosure, there is provided an equipment layout that allows a plurality of complex equipment to utilize space efficiently.

Complex equipment and an equipment layout according to an aspect of the present disclosure can be applied to manufacturing of batteries widely used in green technology fields, including electric vehicles, battery charging stations, and solar and wind power generation using batteries.

Complex equipment and an equipment layout according to an aspect of the present disclosure can be applied to manufacturing of batteries used in eco-friendly electric vehicles, hybrid vehicles, etc., to mitigate climate change by reducing air pollution and greenhouse gas emissions.

According to an aspect of the present disclosure, there is provided complex equipment including: a positive electrode manufacturing machine configured to form a positive electrode by creating a tab on a positive electrode sheet running in a first direction, and drying and cutting the sheet; a negative electrode manufacturing machine configured to form a negative electrode by creating a tab on a negative electrode sheet running in the first direction, and drying cutting the sheet, and placed parallel to the positive electrode manufacturing machine; a positive electrode first direction transporter configured to transport the positive electrode output from the positive electrode manufacturing machine in the first direction; a negative electrode first direction transporter configured to transport the negative electrode output from the negative electrode manufacturing machine in the first direction; at least one first stacker positioned on an opposite side of the negative electrode first direction transporter with the positive electrode first direction transporter at a center, and configured to form an electrode assembly by stacking the positive electrode, a separator, and the negative electrode; at least one second stacker positioned on an opposite side of the positive electrode first direction transporter with the negative electrode first direction transporter at a center, and configured to form an electrode assembly by stacking the positive electrode, a separator, and the negative electrode; at least one positive electrode second direction transporter configured to transport a positive electrode transported on the positive electrode first direction transporter in a second direction and supply the positive electrode to the at least one first stacker and the at least one second stacker; and at least one negative electrode second direction transporter configured to transport a negative electrode transported on the negative electrode first direction transporter in the second direction and supply the negative electrode to the at least one first stacker and the at least one second stacker.

According to an embodiment, the positive electrode manufacturing machine may include: a positive electrode notching machine configured to form a tab on a positive electrode sheet running in the first direction; a positive electrode dryer configured to dry the positive electrode sheet on which the tab is formed; and a positive electrode cutter configured to cut the dried positive electrode sheet to create a positive electrode.

According to an embodiment, the negative electrode manufacturing machine may include: a negative electrode notching machine configured to form a tab on a negative electrode sheet running in the first direction; a negative electrode dryer configured to dry the negative electrode sheet on which the tab is formed; and a negative electrode cutter configured to cut the dried negative electrode sheet to create a negative electrode.

According to an embodiment, the positive electrode manufacturing machine may include: a positive electrode dryer configured to dry a positive electrode sheet running in the first direction; a positive electrode notching machine configured to form a tab on the dried positive electrode sheet; and a positive electrode cutter configured to cut the positive electrode sheet on which the tab is formed to create a positive electrode.

According to an embodiment, the negative electrode manufacturing machine may include: a negative electrode dryer configured to dry a negative electrode sheet running in the first direction; a negative electrode notching machine configured to form a tab on the dried negative electrode sheet; and a negative electrode cutter configured to cut the negative electrode sheet on which the tab is formed to create a negative electrode.

According to an embodiment, the complex equipment may further include: a positive electrode unwinder configured to unwind a positive electrode sheet roll in the first direction and supply the positive electrode sheet to the positive electrode manufacturing machine; and a negative electrode unwinder configured to unwind a negative electrode sheet roll in the first direction and supply the negative electrode sheet to the negative electrode manufacturing machine.

According to an embodiment, the complex equipment may further include: a positive electrode roll replacement device configured to discharge an exhausted positive electrode sheet roll and replaces the exhausted positive electrode sheet roll with a prepared new positive electrode sheet roll when a positive electrode sheet roll of the positive electrode unwinder is exhausted; and a negative electrode roll replacement device configured to discharge an exhausted negative electrode sheet roll and replaces the exhausted negative electrode sheet roll with a prepared new negative electrode sheet roll when a negative electrode sheet roll of the negative electrode unwinder is exhausted.

According to an embodiment, the positive electrode second direction transporter may include: a positive electrode bridge located between the positive electrode first direction transporter and the negative electrode first direction transporter, and on which the positive electrode is seated; a first positive electrode supplier configured to supply a positive electrode on the positive electrode first direction transporter to the at least one first stacker, and move another positive electrode on the positive electrode first direction transporter to the positive electrode bridge; and a second positive electrode supplier configured to supply the positive electrode on the positive electrode bridge to the at least one second stacker.

According to an embodiment, the negative electrode second direction transporter may include: a negative electrode bridge located between the positive electrode first direction transporter and the negative electrode first direction transporter, and on which the negative electrode is seated; a first negative electrode supplier configured to supply a negative electrode on the negative electrode first direction transporter to the at least one second stacker, and move another negative electrode on the negative electrode first direction transporter to the negative electrode bridge; and a second negative electrode supplier configured to supply the negative electrode on the negative electrode bridge to the at least one first stacker.

According to an embodiment, the first positive electrode supplier may include: a first pickup part configured to pick up a positive electrode from the positive electrode first direction transporter and supply the positive electrode to the at least one first stacker; a second pickup part configured to pick up a positive electrode from the positive electrode first direction transporter and move the positive electrode to the positive electrode bridge; and a first supply driving part configured to move the first pickup part and the second pickup part simultaneously in the second direction perpendicular to the first direction.

According to an embodiment, the first negative electrode supplier may include: a third pickup part configured to pick up a negative electrode from the negative electrode first direction transporter and supply the negative electrode to the at least one first stacker; a fourth pickup part configured to pick up a negative electrode from the negative electrode first direction transporter and move the negative electrode to the negative electrode bridge; and a second supply driving part configured to move the third pickup part and the fourth pickup part simultaneously in the second direction perpendicular to the first direction.

According to an embodiment, the complex equipment may further include: a negative electrode floating table spaced above the positive electrode first direction transporter and on which the negative electrode is seated; and a positive electrode floating table spaced above the negative electrode first direction transporter and on which the positive electrode is seated.

According to an embodiment, the second positive electrode supplier may include: a fifth pickup part configured to pick up a positive electrode from the positive electrode bridge and move the positive electrode to the positive electrode floating table; a sixth pickup part configured to pick up the positive electrode from the positive electrode floating table and supply the picked-up positive electrode to the at least one second stacker; and a third supply driving part configured to move the fifth pickup part and the sixth pickup part simultaneously in the second direction perpendicular to the first direction.

According to an embodiment, the second negative electrode supplier may include: a seventh pickup part configured to pick up a negative electrode from the negative electrode bridge and move the negative electrode to the negative electrode floating table; an eighth pickup part configured to pick up the negative electrode from the negative electrode floating table and supply the picked-up negative electrode to the at least one first stacker; and a fourth supply driving part configured to move the seventh pickup part and the eighth pickup part simultaneously in the second direction perpendicular to the first direction.

According to an embodiment, the complex equipment may further include: a negative electrode partition located between the positive electrode first direction transporter and the negative electrode floating table, and configured to extend along a path along which the second negative electrode supplier moves the negative electrode to prevent negative electrode particles falling from the negative electrode from falling on the positive electrode first direction transporter; and a positive electrode partition located between the negative electrode first direction transporter and the positive electrode floating table, and configured to extend along a path along which the second positive electrode supplier moves the positive electrode to prevent positive electrode particles falling from the positive electrode from falling on the negative electrode first direction transporter.

According to an embodiment, the positive electrode bridge may move a positive electrode moved by the first positive electrode supplier to a position where the positive electrode is picked up by the second positive electrode supplier, and the negative electrode bridge may move a negative electrode moved by the first negative electrode supplier to a position where the negative electrode is picked up by the second negative electrode supplier.

According to an embodiment, the first pickup part and the second pickup part of the first positive electrode supplier may be reciprocally moved in the second direction by the first supply driving part to repeat a set motion in a first motion section and a second motion section, and the third pickup part and the fourth pickup part of the first negative electrode supplier may be reciprocally moved in the second direction by the second supply driving part to repeat a set motion in the first motion section and the second motion section, wherein in the first motion section, when the first pickup part of the first positive electrode supplier picks up a positive electrode from the positive electrode first direction transporter, at the same time, the second pickup part of the first positive electrode supplier may release a positive electrode to the at least one first stacker, whereas when the third pickup part of the first negative electrode supplier picks up a negative electrode from the negative electrode first direction transporter, at the same time, the fourth pickup part of the first negative electrode supplier may release a negative electrode to the at least one second stacker, and in the second motion section, when the first pickup part of the first positive electrode supplier releases a positive electrode to the positive electrode bridge, at the same time, the second pickup part of the first positive electrode supplier may pick up a positive electrode from the positive electrode first direction transporter, whereas when the third pickup part of the first negative electrode supplier releases a negative electrode to the negative electrode bridge, at the same time, the fourth pickup part of the first negative electrode supplier may pick up a negative electrode from the negative electrode first direction transporter.

According to an embodiment, the fifth pickup part and the sixth pickup part of the second positive electrode supplier may be reciprocally moved in the second direction by the third supply driving part to repeat a set motion in a first motion section and a second motion section, and the seventh pickup part and the eighth pickup part of the second negative electrode supplier may be reciprocally moved in the second direction by the fourth supply driving part to repeat a set motion in the first motion section and the second motion section, wherein in the first motion section, when the fifth pickup part of the second positive electrode supplier picks up a positive electrode from the positive electrode bridge, at the same time, the sixth pickup part of the second positive electrode supplier may pick up a positive electrode from the positive electrode floating table, whereas when the seventh pickup part of the second negative electrode supplier picks up a negative electrode from the negative electrode bridge, at the same time, the eighth pickup part of the second negative electrode supplier may pick up a negative electrode from the negative electrode floating table, and in the second motion section, when the fifth pickup part of the second positive electrode supplier releases a positive electrode to the positive electrode floating table, at the same time, the sixth pickup part of the second positive electrode supplier may release a positive electrode to the at least one second stacker, whereas when the seventh pickup part of the second negative electrode supplier releases a negative electrode to the negative electrode floating table, at the same time, the eighth pickup part of the second negative electrode supplier may release a negative electrode to the at least one first stacker.

According to an embodiment, the first positive electrode supplier, the positive electrode bridge, and the second positive electrode supplier may be arranged on the same line in the second direction, and the first negative electrode supplier, the negative electrode bridge, and the second negative electrode supplier may be arranged on the same line in the second direction.

According to an aspect of the present disclosure, there is provided an equipment layout including: the complex equipment including a plurality of complex equipment described above; a plurality of first carriers configured to transport an electrode assembly manufactured by a first stacker and a second stacker of the plurality of composite equipment in a first direction; and a second carrier configured to receive an electrode assembly transported by the plurality of first carriers and transport the electrode assembly in a second direction.

According to an embodiment, the plurality of composite equipment may be arranged at set intervals along the second carrier extending in the second direction.

According to an embodiment, the equipment layout may further include a self-moving roll transport unit configured to transport a positive electrode sheet roll or a negative electrode sheet roll to the plurality of composite equipment.

The features and advantages of the present disclosure will become more apparent from the following detailed description based on the accompanying drawings.

Prior to this, terms or words used in this specification and claims should not be construed in their usual, dictionary meaning, and should be interpreted with meaning and concept consistent with the technical idea of the present disclosure on the basis of the principle that the inventor can define terminology appropriately to explain his or her invention in the best way possible.

According to an embodiment of the present disclosure, it is possible to minimize defects that arise during transporting of electrodes between drying, notching, and stacking processes.

According to an embodiment of the present disclosure, it is possible to efficiently utilize the space of secondary battery manufacturing plants.

### BRIEF DESCRIPTION OF THE DRAWINGS

FIG. 1 is a view showing complex equipment according to an embodiment.

FIG. 2 is a plan view showing complex equipment of a first motion section according to an embodiment.

FIG. 3 is a plan view showing complex equipment of a second motion section according to an embodiment.

FIG. 4 is a side view of a positive electrode line of complex equipment according to an embodiment.

FIG. 5 is a side view of a negative electrode line of complex equipment according to an embodiment.

FIG. 6 is a plan view showing complex equipment performing post-dry notching according to an embodiment.

FIG. 7 is a side view of a positive electrode line of the complex equipment of FIG. 6.

FIG. 8 is a side view of a negative electrode line of the complex equipment of FIG. 6.

FIG. 9 is a view showing a rotation-type stacker according to an embodiment.

FIG. 10 is a view showing a fixed-type stacker according to an embodiment.

FIG. 11 is a view showing the operation of a first positive electrode supply part and a second positive electrode supply part in the first motion section and the second motion section according to an embodiment.

FIG. 12 is a view showing the operation of a first negative electrode supply part and a second negative electrode supply part in the first motion section and the second motion section according to an embodiment.

FIG. 13 is a view showing an equipment layout according to an embodiment.

### DETAILED DESCRIPTION

Hereinafter, the present disclosure will be described in detail (with reference to the attached drawings). However, this is only exemplary and the present disclosure is not limited to the specific embodiments described as exemplary.

Hereinafter, with reference to the attached drawings, an embodiment of the present disclosure is described in detail.

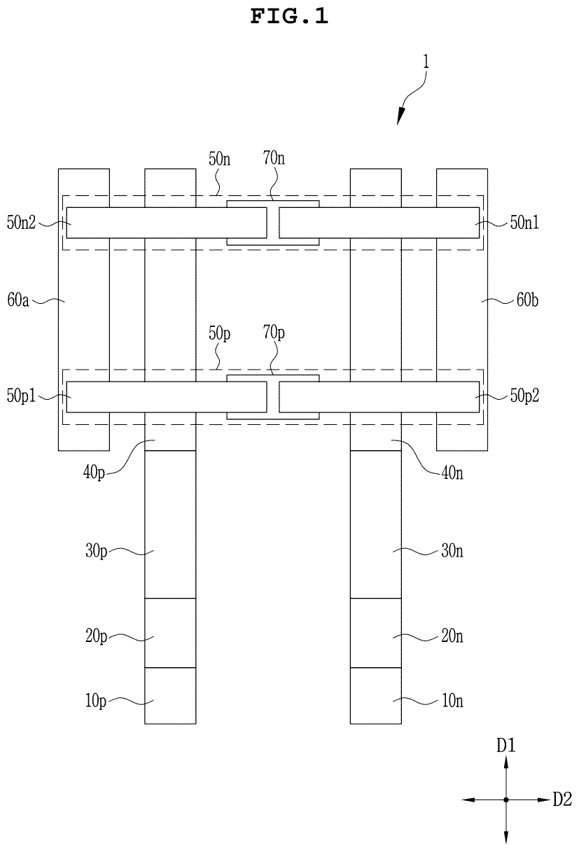

FIG. 1 is a view showing complex equipment 1 according to an embodiment.

The complex equipment 1 may perform notching and stacking in a single flow. The notching is a process where a tab is created on an electrode sheet and the sheet is cut to separate the electrode, and stacking is a process where a negative electrode 5n, a separator 7, and a positive electrode 5p are stacked to form an electrode assembly 6.

The complex equipment 1 according to an embodiment may include: a positive electrode manufacturing machine 30p configured to form a positive electrode 5p by creating a tab on a positive electrode sheet 3p running in a first direction D1, drying the sheet, and cutting the sheet; a negative electrode manufacturing machine 30n configured to form a negative electrode 5n by creating a tab on a negative electrode sheet 3n running in the first direction D1, drying the sheet, and cutting the sheet, and placed parallel to the positive electrode manufacturing machine 30p; a positive electrode first direction transporter 40p for transporting a positive electrode 5p output from the positive electrode manufacturing machine 30p in the first direction D1; a negative electrode first direction transporter 40n for transporting a negative electrode 5n output from the negative electrode manufacturing machine 30n in the first direction D1; at least one first stacker 60a positioned on the opposite side of the negative electrode first direction transporter 40n with the positive electrode first direction transporter 40p at the center, and configured to form an electrode assembly 6 by stacking the positive electrode 5p, a separator 7, and the negative electrode 5n; at least one second stacker 60b positioned on the opposite side of the positive electrode first direction transporter 40p with the negative electrode first direction transporter 40n at the center, and configured to form an electrode assembly 6 by stacking the positive electrode 5p, a separator 7, and the negative electrode 5n; at least one positive electrode second direction transporter 50p that transports a positive electrode 5p transported on the positive electrode first direction transporter 40p in a second direction and supplies the positive electrode 5p to the first stacker 60a and the second stacker 60b; and at least one negative electrode second direction transporter 50n that transports a negative electrode 5n transported on the negative electrode first direction transporter 40n in the second direction and supplies the negative electrode 5n to the first stacker 60a and the second stacker 60b.

The complex equipment 1 according to an embodiment may further include: a positive electrode unwinder 20p that unwinds a positive electrode sheet roll 2p in the first direction D1 and supplies a positive electrode sheet 3p to the positive electrode manufacturing machine 30p; and a negative electrode unwinder 20n that unwinds a negative electrode sheet roll 2n in the first direction D1 and supplies a negative electrode sheet 3n to the negative electrode manufacturing machine 30n.

The complex equipment 1 according to an embodiment may further include: a positive electrode roll replacement device 10p that discharges an exhausted positive electrode sheet roll 2p and replaces the exhausted positive electrode sheet roll 2p with a prepared new positive electrode sheet roll 2p when a positive electrode sheet roll 2p of the positive electrode unwinder 20p is exhausted; and a negative electrode roll replacement device 10n that discharges an exhausted negative electrode sheet roll 2n and replaces the exhausted negative electrode sheet roll 2n with a prepared new negative electrode sheet roll 2n when a negative electrode sheet roll 2n of the negative electrode unwinder 20n is exhausted.

The complex equipment 1 may have a positive electrode line consisting of the positive electrode roll replacement device 10p, the positive electrode unwinder 20p, the positive electrode manufacturing machine 30p, and the positive electrode first direction transporter 40p, and a negative electrode line consisting of the negative electrode roll replacement device 10n, the negative electrode unwinder 20n, the negative electrode manufacturing machine 30n, and the negative electrode first direction transporter 40n arranged parallel to each other in the first direction D1.

The positive electrode first direction transporter 40p and the negative electrode first direction transporter 40n may include a conveyor belt, a linear motion system (LMS), or other devices capable of transporting electrodes. The positive electrode 5p and the negative electrode 5n manufactured in the positive electrode manufacturing machine 30p and the negative electrode manufacturing machine 30n may be directly supplied to the positive electrode first direction transporter 40p and the negative electrode first direction transporter 40n. The positive electrode first direction transporter 40p and the negative electrode first direction transporter 40n may transport the positive electrode 5p and the negative electrode 5n in the first direction D1. The positive electrode 5p and the negative electrode 5n transported in the first direction D1 may be supplied to the first stacker 60a and the second stacker 60b by the positive electrode second direction transporter 50p and the negative electrode second direction transporter 50n.

Since the positive electrode 5p and the negative electrode 5n are not stored in the magazine after being manufactured, the positive electrode 5p and the negative electrode 5n can avoid damage that may occur during the process of storing and withdrawing the positive electrode 5p and the negative electrode 5n from the magazine. Various damages, for example, the edge of the positive electrode 5p colliding with the magazine to be bent or torn, or cracks in the active material, may occur. The positive electrode 5p and the negative electrode 5n may be moved by the positive electrode first direction transporter 40p and the negative electrode first direction transporter 40n, and be supplied to the stackers by the positive electrode second direction transporter 50p and the negative electrode second direction transporter 50n. Thus, damages to the positive electrode 5p and the negative electrode 5n that may occur during the transport process may be minimized.

The first stacker 60a and the second stacker 60b may be placed on the outer side of the positive electrode line and the negative electrode line. Accordingly, a worker is able to perform the necessary work on the first stacker 60a and the second stacker 60b on the outer side of the positive electrode line and the negative electrode line. To be specific, the first stacker 60a may be placed on the opposite side of the negative electrode first direction transporter 40n with the positive electrode first direction transporter 40p as the center. The second stacker 60b may be placed on the opposite side of the positive electrode first direction transporter 40p with the negative electrode first direction transporter 40n as the center. In other words, the positive electrode first direction transporter 40p and the negative electrode first direction transporter 40n are arranged between the first stacker 60a and the second stacker 60b.

Since the first stacker 60a and the second stacker 60b are not located between the positive electrode line and the negative electrode line, it is easy for the worker to access the first stacker 60a and the second stacker 60b. Automated equipment requiring maintenance work (the positive electrode unwinder 20p, the negative electrode unwinder 20n, the positive electrode roll replacement device 10p, the negative electrode roll replacement device 10n, the positive electrode manufacturing machine 30p, the negative electrode manufacturing machine 30n, the first direction transporters 40p and 40n, the second direction transporters 50p and 50n, the first stacker 60a, and the second stacker 60b) is accessible to the worker from the outside of the positive electrode line and the negative electrode line. Since only a positive electrode bridge 70p and a negative electrode bridge 70n are located between the positive electrode line and the negative electrode line, the positive electrode line and the negative electrode line may be placed close to each other. That is, the left-and-right size (length in the second direction D2) of the composite equipment 1 may be minimized. Accordingly, the path for the worker to move from outside the positive electrode line to outside the negative electrode line may be minimized. In addition, the area occupied by the complex equipment 1 may be reduced, and the area of the entire manufacturing plant may be reduced. In other words, it is possible to efficiently utilize the space of a secondary battery manufacturing plant.

The positive electrode second direction transporter 50p may include: the positive electrode bridge 70p located between the positive electrode first direction transporter 40p and the negative electrode first direction transporter 40n, and on which a positive electrode 5p is seated; a first positive electrode supplier 50p1 that supplies a positive electrode 5p on the positive electrode first direction transporter 40p to the first stacker 60a, and moves another positive electrode 5p on the positive electrode first direction transporter 40p to the positive electrode bridge 70p; and a second positive electrode supplier 50p2 that supplies the positive electrode 5p on the positive electrode bridge 70p to the second stacker 60b.

The negative electrode second direction transporter 50n may include: the negative electrode bridge 70n located between the positive electrode first direction transporter 40p and the negative electrode first direction transporter 40n, and on which a negative electrode 5n is seated; a first negative electrode supplier 50n1 that supplies a negative electrode 5n on the negative electrode first direction transporter 40n to the second stacker 60b, and moves another negative electrode 5n on the negative electrode first direction transporter 40n to the negative electrode bridge 70n; and a second negative electrode supplier 50n2 that supplies the negative electrode 5n on the negative electrode bridge 70n to the first stacker 60a.

The first positive electrode supplier 50p1 and the second positive electrode supplier 50p2 may be arranged in parallel in the second direction D2 perpendicular to the first direction D1. The first positive electrode supplier 50p1 may supply positive electrodes 5p to the first stacker 60a, whereas the second positive electrode supplier 50p2 may supply positive electrodes 5p to the second stacker 60b. The first negative electrode supplier 50n1 and the second negative electrode supplier 50n2 may be arranged in parallel in the second direction D2 perpendicular to the first direction D1. The first negative electrode supplier 50n1 may supply negative electrodes 5n to the second stacker 60b, whereas the second negative electrode supplier 50n2 may supply negative electrodes 5n to the first stacker 60a. The first positive electrode supplier 50p1 and the second negative electrode supplier 50n2 may be disposed on the positive electrode first direction transporter 40p. The second positive electrode supplier 50p2 and the first negative electrode supplier 50n1 may be disposed on the negative electrode first direction transporter 40n. In FIG. 1, it can be confirmed that the first positive electrode supplier 50p1 and the second positive electrode supplier 50p2 are placed close to the positive electrode manufacturing machine 30p and the negative electrode manufacturing machine 30n, respectively, and the first negative electrode supplier 50n1 and the second negative electrode supplier 50n2 are placed far from the negative electrode manufacturing machine 30n and the positive electrode manufacturing machine 30p, respectively. Unlike the case in FIG. 1, the first positive electrode supplier 50p1 and the second positive electrode supplier 50p2 may be placed far from the positive electrode manufacturing machine 30p and the negative electrode manufacturing machine 30n, and the first negative electrode supplier 50n1 and the second negative electrode supplier 50n2 may be placed close to the negative electrode manufacturing machine 30n and the positive electrode manufacturing machine 30p.

The operations of the positive electrode manufacturing machine 30p, the positive electrode first direction transporter 40p, the positive electrode suppliers 50p1 and 50p2, the first stacker 60a, the negative electrode manufacturing machine 30n, the negative electrode first direction transporter 40n, the negative electrode suppliers 50n1 and 50n2, the second stacker 60b may be organically connected so as to operate as one facility.

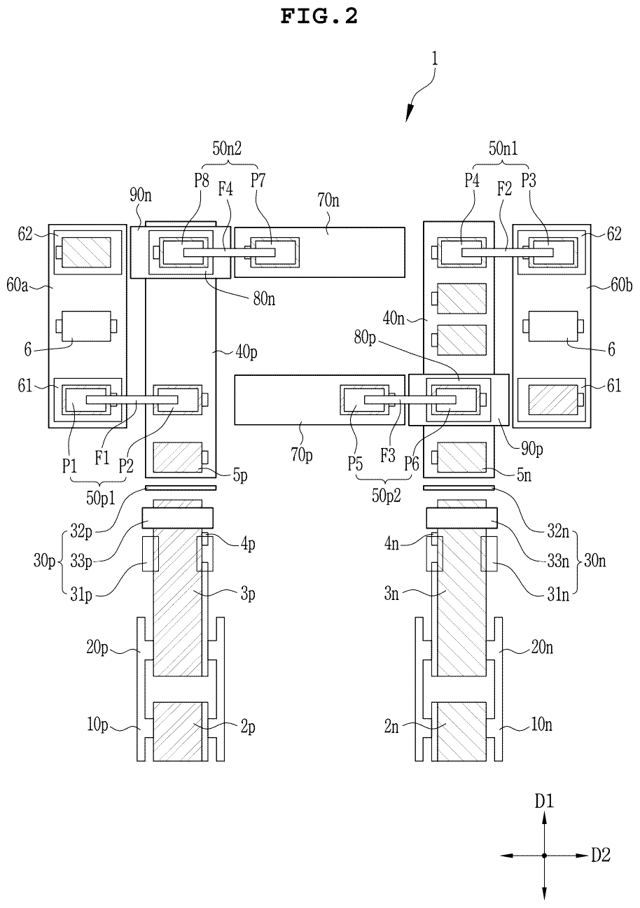

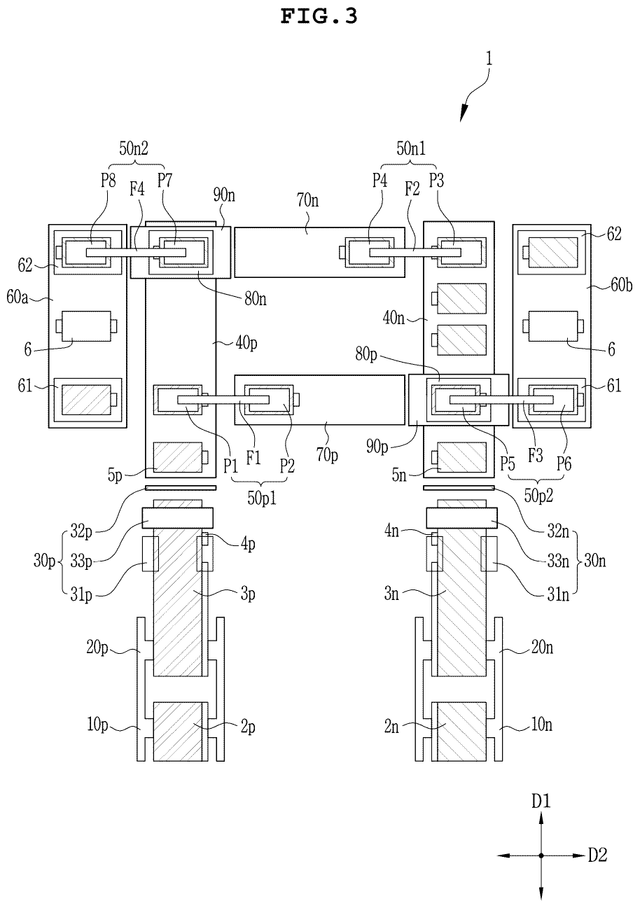

FIG. 2 is a plan view showing the complex equipment 1 of a first motion section E1 according to an embodiment, and FIG. 3 is a plan view showing the complex equipment 1 of a second motion E2 section according to an embodiment. In FIGS. 2 and 3, the first stacker 60a and the second stacker 60b are illustrated in a simplified manner. In FIGS. 2 and 3, each configuration of the composite equipment 1 is illustrated in a simplified manner.

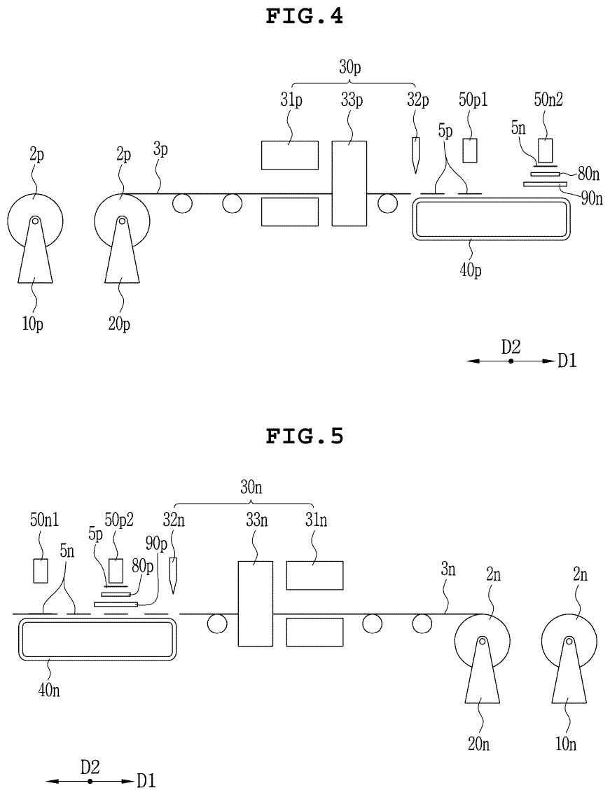

FIG. 4 is a side view of a positive electrode line of the complex equipment 1 according to an embodiment, and FIG. 5 is a side view of a negative electrode line of the complex equipment 1 according to an embodiment. FIGS. 4 and 5 are illustrated based on the first motion section E1. FIG. 4 is illustrated in the direction looking from the negative electrode line to the positive electrode line.

FIG. 5 is illustrated in the direction looking from the positive electrode line to the negative electrode line. FIGS. 2 to 5 are referenced together. The positive electrode sheet roll 2p is a roll in which the positive electrode sheet 3p is wound. The positive electrode sheet 3p may include a current collector and a positive electrode active material coated on one or both sides of the current collector. The current collector may be formed of a metal foil. The positive electrode sheet 3p may be formed by coating the positive electrode active material on the current collector. The positive electrode sheet 3p may be may be supplied to the positive electrode unwinder 20p in a state of being wound on a roll.

The negative electrode sheet roll 2n is a roll in which the negative electrode sheet 3n is wound. The negative electrode sheet 3n may include a current collector and a negative electrode active material coated on one or both sides of the current collector. The current collector may be formed of a metal foil. The negative electrode sheet 3n may be formed by coating the negative electrode active material on the current collector. The negative electrode sheet 3n may be may be supplied to the negative electrode unwinder 20n in a state of being wound on a roll.

The positive electrode unwinder 20p is a device that unwinds the positive electrode sheet roll 2p. The positive electrode unwinder 20p may unwind the positive electrode sheet roll 2p so that the positive electrode sheet 3p runs in the first direction D1. The positive electrode sheet 3p output from the positive electrode unwinder 20p may be input to the positive electrode manufacturing machine 30p. The positive electrode unwinder 20p and the positive electrode manufacturing machine 30p may be arranged in parallel in the first direction D1.

The negative electrode unwinder 20n is a device that unwinds the negative electrode sheet roll 2n. The negative electrode unwinder 20n may unwind the negative electrode sheet roll 2n so that the negative electrode sheet 3n runs in the first direction D1. The negative electrode sheet 3n output from the negative electrode unwinder 20n may be input to the negative electrode manufacturing machine 30n. The negative electrode unwinder 20n and the negative electrode manufacturing machine 30n may be arranged in parallel in the first direction D1.

The positive electrode unwinder 20p and the negative electrode unwinder 20n may be spaced apart and arranged parallel in the second direction D2 perpendicular to the first direction D1.

The positive electrode roll replacement device 10p may supply the positive electrode sheet roll 2p to the positive electrode unwinder 20p. The positive electrode roll replacement device 10p may include a grip device, a driving part, a frame, etc., for transporting the positive electrode sheet roll 2p to the positive electrode unwinder 20p. The positive electrode roll replacement device 10p may withdraw an empty positive electrode sheet roll 2p from the positive electrode unwinder 20p and input a new positive electrode sheet roll 2p when the positive electrode unwinder 20p exhausts the positive electrode sheet roll 2p. The positive electrode roll replacement device 10p may be arranged parallel to the positive electrode unwinder 20p in the first direction D1.

The negative electrode roll replacement device 10n may supply the negative electrode sheet roll 2n to the negative electrode unwinder 20n. The negative electrode roll replacement device 10n may include a grip device, a driving part, a frame, etc., for transporting the negative electrode sheet roll 2n to the negative electrode unwinder 20n. The negative electrode roll replacement device 10n may withdraw an empty negative electrode sheet roll 2n from the negative electrode unwinder 20n and input a new negative electrode sheet roll 2n when the negative electrode unwinder 20n exhausts the negative electrode sheet roll 2n. The negative electrode roll replacement device 10n may be arranged parallel to the negative electrode unwinder 20n in the first direction D1.

The positive electrode roll replacement device 10p and the negative electrode roll replacement device 10n may be spaced apart and arranged parallel in the second direction D2 perpendicular to the first direction D1.

The positive electrode manufacturing machine 30p may receive a positive electrode sheet 3p provided by the positive electrode unwinder 20p and perform notching, drying, and cutting to manufacture a positive electrode 5p. The positive electrode manufacturing machine 30p may include: a positive electrode notching machine 31p for forming a tab on a positive electrode sheet 3p running in the first direction D1; a positive electrode dryer 33p for drying the positive electrode sheet 3p on which the tabis formed; and a positive electrode cutter 32p that cuts the dried positive electrode sheet 3p to form a positive electrode 5p.

The positive electrode notching machine 31p may cut off a portion of a current collector that is not coated with a positive electrode active material from a positive electrode sheet 3p. The portion of the current collector left on the positive electrode sheet 3p may become a positive electrode tab 4p of the positive electrode 5p. The positive electrode notching machine 31p may create the positive electrode tab 4p by pressing opposite sides of the positive electrode sheet 3p using a mold. Alternatively, the positive electrode notching machine 31p may create the positive electrode tab 4p by cutting a portion of the positive electrode sheet 3p using a cylindrical cutter. Alternatively, the positive electrode notching machine 31p may create the positive electrode tab 4p using laser cutting, etc. The electrode sheet that has passed through the positive electrode notching machine 31p may travel in the first direction D1 and be output to the positive electrode dryer 33p.

The positive electrode dryer 33p may dry the positive electrode sheet 3p on which the tab is created. The positive electrode dryer 33p may heat the positive electrode sheet 3p on which the tab is created. The positive electrode dryer 33p may include a laser dryer, a hot air dryer, etc. The positive electrode sheet 3p dried by the positive electrode dryer 33p may travel in the first direction D1 and be output to the positive electrode cutter 32p.

The positive electrode cutter 32p may form the positive electrode 5p by cutting the positive electrode sheet 3p on which the tab is created and dried at set intervals. The positive electrode cutter 32p may press and cut one or both sides of the positive electrode sheet 3p using a blade. Alternatively, the positive electrode cutter 32p may form the positive electrode 5p by cutting the positive electrode sheet 3p at set intervals using a cylindrical cutter. Alternatively, the positive electrode cutter 32p may form the positive electrode 5p using laser cutting or the like. The positive electrode 5p created by cutting the positive electrode sheet 3p by the positive electrode cutter 32p may be output to the positive electrode first direction transporter 40p.

The negative electrode manufacturing machine 30n may receive a negative electrode sheet 3n provided by the negative electrode unwinder 20n and perform notching, drying, and cutting to manufacture a negative electrode 5n. The negative electrode manufacturing machine 30n may include: a negative electrode notching machine 31n for forming a tab on a negative electrode sheet 3n running in the first direction D1; a negative electrode dryer 33n for drying the negative electrode sheet 3n on which the tab is formed; and a negative electrode cutter 32n that cuts the dried negative electrode sheet 3n to form a negative electrode 5n.

The negative electrode notching machine 31n may cut off a portion of a current collector that is not coated with a negative electrode active material from a negative electrode sheet 3n. The portion of the current collector left on the negative electrode sheet 3n may become a negative electrode tab 4n of the negative electrode 5n. The negative electrode notching machine 31n may create the negative electrode tab 4n by pressing opposite sides of the negative electrode sheet 3n using a mold. Alternatively, the negative electrode notching machine 31n may create the negative electrode tab 4n by cutting a portion of the negative electrode sheet 3n using a cylindrical cutter. Alternatively, the negative electrode notching machine 31n may create the negative electrode tab 4n using laser cutting, etc. The electrode sheet that has passed through the negative electrode notching machine 31n may travel in the first direction D1 and be output to the negative electrode dryer 33n.

The negative electrode dryer 33n may dry the negative electrode sheet 3n on which the tab is created. The negative electrode dryer 33n may heat the negative electrode sheet 3n on which the tab is created. The negative electrode dryer 33n may include a laser dryer, a hot air dryer, etc. The negative electrode sheet 3n dried by the negative electrode dryer 33n may travel in the first direction D1 and be output to the negative electrode cutter 32n.

The negative electrode cutter 32n may form the negative electrode 5n by cutting the negative electrode sheet 3n on which the tab is created and dried at set intervals. The negative electrode cutter 32n may press and cut one or both sides of the negative electrode sheet 3n using a blade. Alternatively, the negative electrode cutter 32n may form the negative electrode 5n by cutting the negative electrode sheet 3n at set intervals using a cylindrical cutter. Alternatively, the negative electrode cutter 32n may form the negative electrode 5n using laser cutting or the like. The negative electrode 5n created by cutting the negative electrode sheet 3n by the negative electrode cutter 32n may be output to the negative electrode first direction transporter 40n.

Since the notching machine 31p or 31n, the dryer 33p or 33n, and the cutter 32p or 32n are arranged in a single piece of complex equipment, the area of the plant may be minimized by not having to independently install devices that perform notching, drying, and cutting. Moreover, if notching, drying, and cutting are performed in separate, independent devices, damages such as meandering, loosening, or detachment of an electrode sheet may occur during the unwinding and rewinding processes performed while transporting the electrode sheet between the devices.

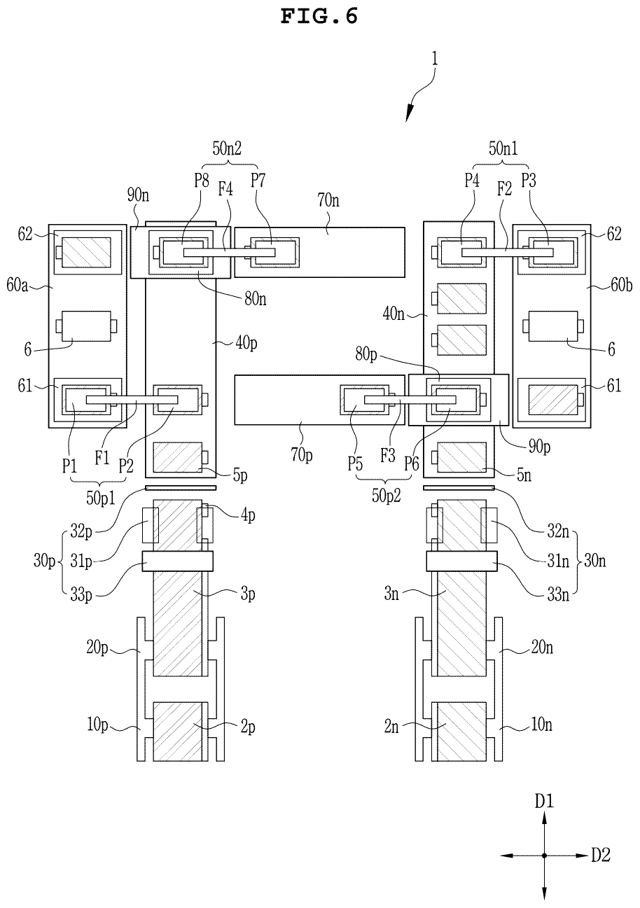

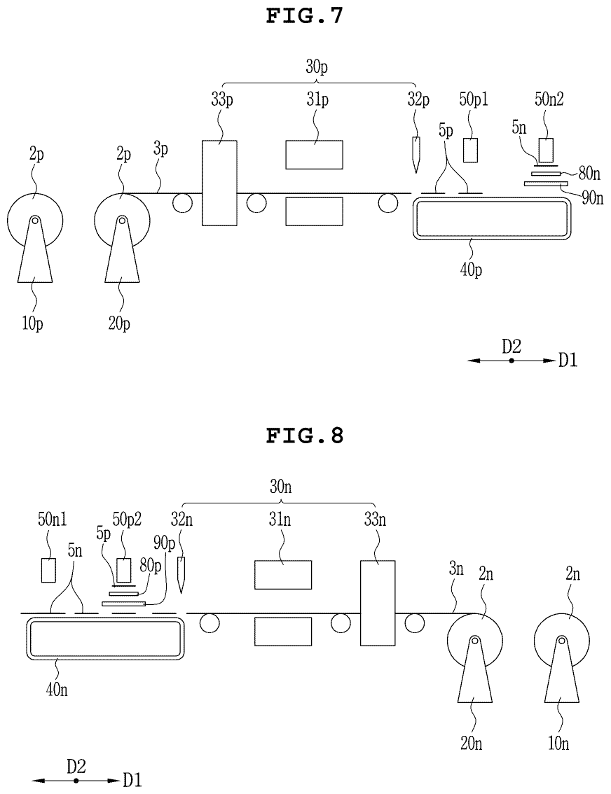

FIG. 6 is a plan view showing complex equipment 1 performing post-dry notching according to an embodiment. FIG. 7 is a side view of a positive electrode line of the complex equipment 1 of FIG. 6. FIG. 8 is a side view of a negative electrode line of the complex equipment 1 of FIG. 6. The complex equipment 1 of FIGS. 6,7, and 8 has a different order of the dryer and the notching machine than the complex equipment 1 of FIGS. 2, 3, 4, and 5.

The positive electrode manufacturing machine 30p may receive a positive electrode sheet 3p provided by the positive electrode unwinder 20p and perform drying, notching, and cutting to manufacture a positive electrode 5p. The positive electrode manufacturing machine 30p may include: a positive electrode dryer 33p for drying a positive electrode sheet 3p running in the first direction D1; a positive electrode notching machine 31p for forming a tab on the dried positive electrode sheet 3p; and a positive electrode cutter 32p that cuts the positive electrode sheet 3p on which the tab is created to form a positive electrode 5p.

The positive electrode dryer 33p may dry a positive electrode sheet 3p running in the first direction D1. The positive electrode dryer 33p may heat the positive electrode sheet 3p. The positive electrode dryer 33p may include a laser dryer, a hot air dryer, etc. The positive electrode sheet 3p dried by the positive electrode dryer 33p may travel in the first direction D1 and be output to the positive electrode notching machine 31p.

The positive electrode notching machine 31p may cut off a portion of a current collector that is not coated with a positive electrode active material from the dried positive electrode sheet 3p. The portion of the current collector left on the positive electrode sheet 3p may become a positive electrode tab 4p of the positive electrode 5p. The positive electrode notching machine 31p may create the positive electrode tab 4p by pressing opposite sides of the positive electrode sheet 3p using a mold. Alternatively, the positive electrode notching machine 31p may create the positive electrode tab 4p by cutting a portion of the positive electrode sheet 3p using a cylindrical cutter. Alternatively, the positive electrode notching machine 31p may create the positive electrode tab 4p using laser cutting, etc. The electrode sheet that has passed through the positive electrode notching machine 31p may travel in the first direction D1 and be output to the positive electrode cutter 32p.

The positive electrode cutter 32p may form the positive electrode 5p by cutting the positive electrode sheet 3p that has been dried and has the tab created at set intervals. The positive electrode cutter 32p may press and cut one or both sides of the positive electrode sheet 3p using a blade. Alternatively, the positive electrode cutter 32p may form the positive electrode 5p by cutting the positive electrode sheet 3p at set intervals using a cylindrical cutter. Alternatively, the positive electrode cutter 32p may form the positive electrode 5p using laser cutting or the like. The positive electrode 5p created by cutting the positive electrode sheet 3p by the positive electrode cutter 32p may be output to the positive electrode first direction transporter 40p.

The negative electrode manufacturing machine 30n may receive a negative electrode sheet 3n provided by the negative electrode unwinder 20n and perform notching, drying, and cutting to manufacture a negative electrode 5n. The negative electrode manufacturing machine 30n may include: a negative electrode dryer 33n for drying a negative electrode sheet 3n running in the first direction D1; a negative electrode notching machine 31n for forming a tab on the dried negative electrode sheet 3n; and a negative electrode cutter 32n that cuts the negative electrode sheet 3n on which the tab is created to form a negative electrode 5n.

The negative electrode dryer 33n may dry a negative electrode sheet 3n running in the first direction D1. The negative electrode dryer 33n may heat the negative electrode sheet 3n. The negative electrode dryer 33n may include a laser dryer, a hot air dryer, etc. The negative electrode sheet 3n dried by the negative electrode dryer 33n may travel in the first direction D1 and be output to the negative electrode notching machine 31n.

The negative electrode notching machine 31n may cut off a portion of a current collector that is not coated with a negative electrode active material from the negative electrode sheet 3n. The portion of the current collector left on the negative electrode sheet 3n may become a negative electrode tab 4n of the negative electrode 5n. The negative electrode notching machine 31n may create the negative electrode tab 4n by pressing opposite sides of the negative electrode sheet 3n using a mold. Alternatively, the negative electrode notching machine 31n may create the negative electrode tab 4n by cutting a portion of the negative electrode sheet 3n using a cylindrical cutter. Alternatively, the negative electrode notching machine 31n may create the negative electrode tab 4n using laser cutting, etc. The electrode sheet that has passed through the negative electrode notching machine 31n may travel in the first direction D1 and be output to the negative electrode cutter 32n.

The negative electrode cutter 32n may form the negative electrode 5n by cutting the negative electrode sheet 3n that has been dried and has the tab created at set intervals. The negative electrode cutter 32n may press and cut one or both sides of the negative electrode sheet 3n using a blade. Alternatively, the negative electrode cutter 32n may form the negative electrode 5n by cutting the negative electrode sheet 3n at set intervals using a cylindrical cutter. Alternatively, the negative electrode cutter 32n may form the negative electrode 5n using laser cutting or the like. The negative electrode 5n created by cutting the negative electrode sheet 3n by the negative electrode cutter 32n may be output to the negative electrode first direction transporter 40n.

In the positive electrode manufacturing machine 30p and the negative electrode manufacturing machine 30n, the order of the dryer 33p or 33n, the notching machine 31p or 31n, and the cutter 32p or 32n may be changed. For example, as shown in FIGS. 2 to 5, the positive electrode manufacturing machine 30p and the negative electrode manufacturing machine 30n may have the notching machine 31p or 31n, the dryer 33p or 33n, and the cutter 32p or 32n in that order. Alternatively, as shown in FIGS. 6 to 8, the positive electrode manufacturing machine 30p and the negative electrode manufacturing machine 30n may have the dryer 33p or 33n, the notching machine 31p or 31n, and the cutter 32p or 32n in that order. Considering the advantages and disadvantages of each order described below, a user can choose which order to place the notching machine, the dryer, and the cutter in depending on the characteristics of the manufacturing process.

The positive electrode manufacturing machine 30p and the negative electrode manufacturing machine 30n described with reference to FIGS. 2 to 5 may perform notching and then drying. As in the structure disclosed in FIGS. 6 to 8, when the electrode sheet (positive electrode sheet 3p or negative electrode sheet 3n) is heated by the dryer 33p or 33n and then notching is performed, the temperature of the current collector increases, and thus the properties of the metal that affect the notching process may change. For example, if the temperature of the electrode sheet (positive electrode sheet 3p or negative electrode sheet 3n) increases, the dimensions may change. In addition, the high-temperature electrode sheet (positive electrode sheet 3p or negative electrode sheet 3n) may come into contact with the mold of the notching machine 31p or 31n, which may increase the temperature of the mold, and affect the notching quality. Therefore, it is necessary to consider the temperature change of the entire collector during notching. In contrast, when drying is performed after notching, as in the structure disclosed in FIGS. 2 to 5, there is no need to consider the temperature change of the entire current collector during notching.

Meanwhile, when drying is performed after notching as in the structure disclosed in FIGS. 2 to 5, a defect may occur in which the tab (positive tab 4p or negative tab 4n) is folded or damaged while the electrode sheet (positive sheet 3p or negative electrode sheet 3n) on which the tab is created travels. This defect may be prevented by minimizing the traveling distance after notching.

The positive electrode manufacturing machine 30p and the negative electrode manufacturing machine 30n described with reference to FIGS. 6 to 8 may perform drying and then notching. As in the structure disclosed in FIGS. 6 to 8, when the tab (positive tab 4p or negative tab 4n) is created on the electrode sheet (positive electrode sheet 3p or negative electrode sheet 3n) by the notching machine 31p or 31n and then drying is performed, while the electrode sheet (positive electrode sheet 3p or negative electrode sheet 3n) is traveling toward the dryer 33p or 33n, the tab (positive tab 4p or negative tab 4n) may be folded or damaged due to various causes, such as vibration of the tab (positive tab 4p or negative tab 4n), contact with a guide roller, and air resistance.

In contrast, as in the structure disclosed in FIGS. 6 to 8, when notching is performed after drying, damage to the tab (positive tab 4p or negative tab 4n)) may be minimized. Accordingly, the quality of the electrode sheet (positive electrode sheet 3p or negative electrode sheet 3n)) may be improved.

Meanwhile, when notching is performed after drying as in the structure disclosed in FIGS. 6 to 8, the temperature of the electrode may increase during the drying process and heat may be transferred to the notching machine 31p or 31n during the notching process. Therefore, the temperature of the mold of the notching machine 31p or 31n may increase, possibly affecting the notching quality. If a cooling section capable of reducing the temperature of the electrode is additionally added at the rear end of the dryer 33p or 33n, the temperature increase of the mold of the notching machine 31p or 31n may be prevented.

FIGS. 2 to 5 are referenced again.

The positive electrode first direction transporter 40p may transport the positive electrode 5p in the first direction D1. The negative electrode first direction transporter 40n may transport the negative electrode 5n in the first direction D1.

The first positive electrode supplier 50p1 may be disposed on the positive electrode first direction transporter 40p. The first positive electrode supplier 50p1 may pick up a positive electrode 5p transported by the positive electrode first direction transporter 40p and provided the positive electrode 5p to the first stacker 60a. The first positive electrode supplier 50p1 may supply the positive electrode 5p to a positive electrode alignment table 61 of the first stacker 60a. The first positive electrode supplier 50p1 may pick up another positive electrode 5p transported by the positive electrode first direction transporter 40p and move another positive electrode 5p to the positive electrode bridge 70p. The positive electrode 5p moved to the positive electrode bridge 70p may be supplied to the second stacker 60b by the second positive electrode supplier 50p2. The second positive electrode supplier 50p2 may supply the positive electrode 5p to a positive electrode alignment table 61 of the second stacker 60b.

The first negative electrode supplier 50n1 may be disposed on the negative electrode first direction transporter 40n. The first negative electrode supplier 50n1 may pick up a negative electrode 5n transported by the negative electrode first direction transporter 40n and provided the negative electrode 5p to the second stacker 60b. The first negative electrode supplier 50n1 may supply the negative electrode 5p to a negative electrode alignment table 62 of the second stacker 60b. The first negative electrode supplier 50n1 may pick up another negative electrode 5n transported by the negative electrode first direction transporter 40n and move another negative electrode 5n to the negative electrode bridge 70n. The negative electrode 5n moved to the negative electrode bridge 70n may be supplied to the first stacker 60a by the second negative electrode supplier 50n2. The second negative electrode supplier 50n2 may supply the negative electrode 5n to a negative electrode alignment table 62 of the first stacker 60a.

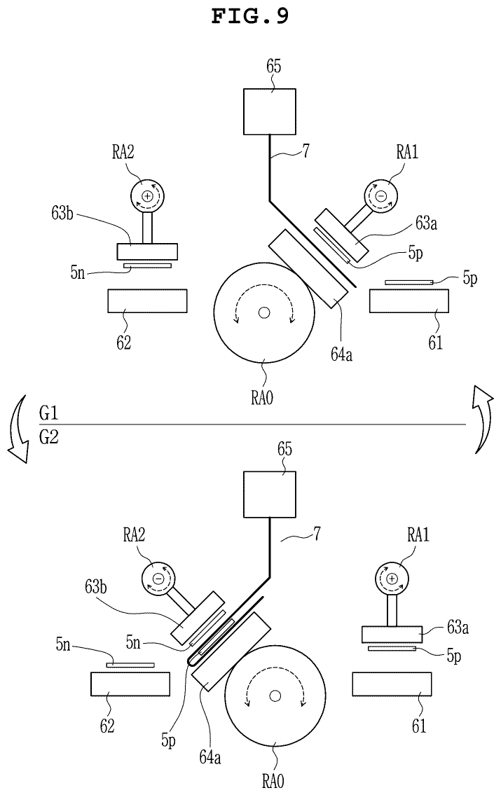

FIG. 9 is a view showing a rotation-type stacker according to an embodiment.

The first stacker 60a and the second stacker 60b may be configured in a rotational manner. The rotational manner is that a rotary stacking table 64a on which the positive electrode 5p, the separator 7, and the negative electrode 5n are stacked reciprocates by a set angle around a rotation axis RA0. The rotation-type stacker may include: the positive electrode alignment table 61 that aligns the position of the positive electrode 5p; the negative electrode alignment table 62 that aligns the position of the negative electrode 5n; a first rotary pickup part 63a that picks up the positive electrode 5p from the positive electrode alignment table 61 and moves the picked-up positive electrode 5p to the rotary stacking table 64a; a second rotary pickup part 63b that picks up the negative electrode 5n from the negative electrode alignment table 62 and moves the picked-up negative electrode 5n to the rotary stacking table 64a; the rotary stacking table 64a that reciprocates by a set angle around the rotation axis RA0, and on which the positive electrode 5p, the separator 7, and the negative electrode 5n are stacked; and a separator supply part 65 that outputs the separator 7 to the upper surface of the rotary stacking table 64a.

The rotation axis RA0 of the rotary stacking table 64a may be located in the lower direction of the rotary stacking table 64a.

The first rotary pickup part 63a may be rotated around a rotation axis RA1 to reciprocate between the positive electrode alignment table 61 and the rotary stacking table 64a. The rotation axis RA1 of the first rotary pickup part 63a may be located in the upper direction of the positive electrode alignment table 61. The first rotary pickup part 63a may be adjusted in length in a direction radiating from the rotation axis RA1 to pick up and release the positive electrode 5p. The second rotary pickup part 63b may be rotated around a rotation axis RA2 to reciprocate between the negative electrode alignment table 62 and the rotary stacking table 64a. The rotation axis RA2 of the second rotary pickup part 63b may be located in the upper direction of the negative electrode alignment table 62. The second rotary pickup part 63b may be adjusted in length in a direction radiating from the rotation axis RA2 to pick up and release the negative electrode 5n.

In a first stacking section G1, the separator supply part 65 may output the separator 7 toward the rotary stacking table 64a. The rotary stacking table 64a may rotate by a set angle so that the upper surface thereof faces the first rotary pickup part 63a. When the rotary stacking table 64a rotates, the separator 7 may cover the rotary stacking table 64a (or the negative electrode 5n). The first rotary pickup part 63a may place the positive electrode 5p on the separator 7 on the upper surface of the rotary stacking table 64a. The second rotary pickup part 63b may pick up the negative electrode 5n from the negative electrode alignment table 62. The positive electrode supply parts may supply the positive electrode 5p to the positive electrode alignment table 61.

In a second stacking section G2, the separator supply part 65 may output the separator 7 toward the rotary stacking table 64a. The rotary stacking table 64a may rotate by a set angle so that the upper surface thereof faces the second rotary pickup part 63b. When the rotary stacking table 64a rotates, the separator 7 may cover the positive electrode 5p (or the rotary stacking table 64a. The second rotary pickup part 63b may place the negative electrode 5n on the separator 7 on the upper surface of the rotary stacking table 64a. The first rotary pickup part 63a may pick up the negative electrode 5n from the positive electrode alignment table 61. The negative electrode supply parts may supply the negative electrode 5n to the negative electrode alignment table 62.

The order of the first stacking section G1 and the second stacking section G2 may be determined to correspond to the operating order of the positive electrode suppliers 50p1 and 50p2 and the negative electrode suppliers 50n1 and 50n2.

The rotation-type stacker may form an electrode assembly 6 in which a positive electrode 5p, a separator 7, and a negative electrode 5n are stacked on the upper surface of the rotary stacking table 64a by repeating the first stacking section G1 and the second stacking section G2. The rotation-type stacker may output an electrode assembly 6 formed by repeating the first stacking section G1 and the second stacking section G2 a set number of times. The electrode assembly 6 may be taken out from the rotation-type stacker by a device using a robot arm and a gripper.

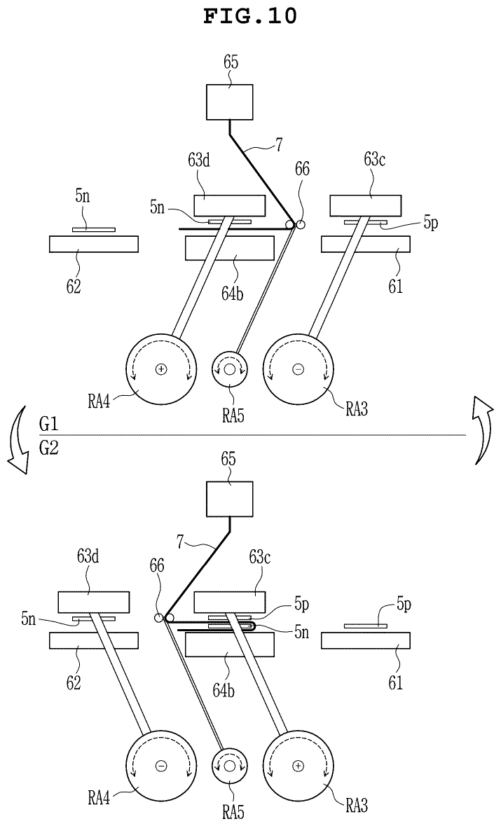

FIG. 10 is a view showing a fixed-type stacker according to an embodiment.

The first stacker 60a and the second stacker 60b may be configured in a fixed manner. The fixed manner is that a fixed stacking table 64b on which the positive electrode 5p, the separator 7, and the negative electrode 5n are stacked does not move. The fixed-type stacker may include: the positive electrode alignment table 61 that aligns the position of the positive electrode 5p; the negative electrode alignment table 62 that aligns the position of the negative electrode 5n; a third rotary pickup part 63c that picks up the positive electrode 5p from the positive electrode alignment table 61 and moves the picked-up positive electrode 5p to the fixed stacking table 64b; a fourth rotary pickup part 63d that picks up the negative electrode 5n from the negative electrode alignment table 62 and moves the picked-up negative electrode 5n to the fixed stacking table 64b; the fixed stacking table 64b having the positive electrode 5p, the separator 7, and the negative electrode 5n stacked on the upper surface thereof; a separator supply part 65 that outputs the separator 7 to the upper surface of the fixed stacking table 64b; and a separator guide part 66 that guides the separator 7 to cover the positive electrode 5p or negative electrode 5n.

The third rotary pickup part 63c may be rotated around a rotation axis RA3 to reciprocate between the positive electrode alignment table 61 and the fixed stacking table 64b. The rotation axis RA3 of the third rotary pickup part 63c may be located in the lower direction of the positive electrode alignment table 61. The third rotary pickup part 63c may be adjusted in length in a direction radiating from the rotation axis RA3 to pick up and release the positive electrode 5p. The fourth rotary pickup part 63d may be rotated around a rotation axis RA4 to reciprocate between the negative electrode alignment table 62 and the fixed stacking table 64b. The rotation axis RA4 of the fourth rotary pickup part 63d may be located in the lower direction of the negative electrode alignment table 62. The fourth rotary pickup part 63d may be adjusted in length in a direction radiating from the rotation axis RA4 to pick up and release the negative electrode 5n.

The separator guide part 66 may include a pair of rollers. The separator 7 may pass between the rollers. The separator guide part 66 may rotate the position of the rollers around a rotation axis RA5. The rotation axis RA5 of the separator guide part 66 may be located in the lower direction of the alignment tables. The separator guide part 66 may guide the separator 7 to cover the positive electrode 5p or negative electrode 5n by moving the rollers back and forth at a set angle in the direction of the positive electrode alignment table 61 and the negative electrode alignment table 62.

In a third stacking section G3, the separator guide part 66 may guide the separator 7 to cover the fixed stacking table 64b (or the positive electrode 5p) by moving the rollers toward the positive electrode alignment table 61. The fourth rotary pickup part 63d may place the negative electrode 5n on the separator 7 on the upper surface of the fixed stacking table 64b. The third rotary pickup part 63c may pick up the positive electrode 5p from the positive electrode alignment table 61. The negative electrode supply parts may supply the negative electrode 5n on the negative electrode alignment table 62.

In a fourth stacking section G4, the separator guide part 66 may guide the separator 7 to cover the negative electrode 5n (or fixed stacking table 64b) by moving the rollers toward the negative electrode alignment table 62. The third rotary pickup part 63c may place the positive electrode 5p on the separator 7 on the upper surface of the fixed stacking table 64b. The fourth rotary pickup part 63d may pick up the negative electrode 5n from the negative electrode alignment table 62. The positive electrode supply parts may supply the positive electrode 5p on the positive electrode alignment table 61.

The order of the third stacking section G3 and the fourth stacking section G4 may be determined to correspond to the operating order of the positive electrode suppliers 50p1 and 50p2 and the negative electrode suppliers 50n1 and 50n2.

The fixed-type stacker may form an electrode assembly 6 in which a positive electrode 5p, a separator 7, and a negative electrode 5n are stacked on the upper surface of the fixed stacking table 64b by repeating the third stacking section G3 and the fourth stacking section G4. The fixed-type stacker may output an electrode assembly 6 formed by repeating the third stacking section G3 and the fourth stacking section G4 a set number of times. The electrode assembly 6 may be taken out from the fixed-type stacker by a device using a robot arm and a gripper.

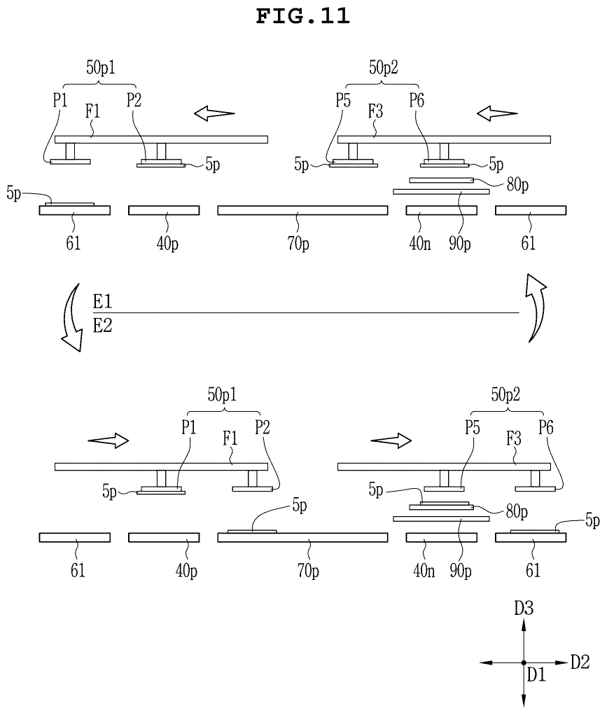

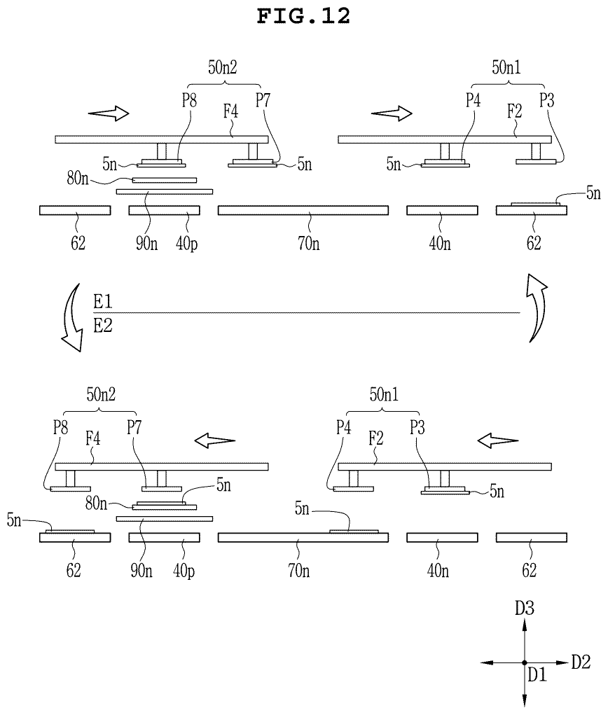

FIG. 11 is a view showing the operation of the first positive electrode supplier 50p1 and the second positive electrode supplier 50p2 in the first motion section E1 and the second motion section E2 according to an embodiment. FIG. 11 illustrates the first positive electrode supplier 50p1 and the second positive electrode supplier 50p2 in the direction looking from the positive electrode unwinder 20p to the positive electrode manufacturing machine 30p. FIG. 12 is a view showing the operation of the first negative electrode supplier 50n1 and the second negative electrode supplier 50n2 in the first motion section E1 and the second motion section E2 according to an embodiment. FIG. 12 illustrates the first negative electrode supplier 50n1 and the second negative electrode supplier 50n2 in the direction looking from the negative electrode unwinder 20n to the negative electrode manufacturing machine 30n. FIGS. 2 and 3 are referenced together.

The positive electrode supplier 50p1 and 50p2 is a device that picks up a positive electrode 5p transported by the positive electrode first direction transporter 40p and supplies the positive electrode 5p to the stacker. The positive electrode supplier 50p1 and 50p2 may include the first positive electrode supplier 50p1 and the second positive electrode supplier 50p2. The negative electrode supplier 50n1 and 50n2 is a device that picks up a negative electrode 5n transported by the negative electrode first direction transporter 40n and supplies the negative electrode 5n to the stacker. The negative electrode supplier 50n1 and 50n2 may include the first negative electrode supplier 50n1 and the second negative electrode supplier 50n2.

The first positive electrode supplier 50p1 and the first negative electrode supplier 50n1 may operate in a similar order. The first positive electrode supplier 50p1 may pick up a positive electrode 5p from the positive electrode first direction transporter 40p and supply the positive electrode 5p directly to the first stacker 60a. The first negative electrode supplier 50n1 may pick up a negative electrode 5n from the negative electrode first direction transporter 40n and supply the negative electrode 5n directly to the second stacker 60b.

The first positive electrode supplier 50p1 may include: a first pickup part P1 that picks up a positive electrode 5p from the positive electrode first direction transporter 40p and supplies the positive electrode 5p to the first stacker 60a; a second pickup part P2 that picks up a positive electrode 5p from the positive electrode first direction transporter 40p and moves the positive electrode 5p to the positive electrode bridge 70p; and a first supply driving part F1 that moves the first pickup part P1 and the second pickup part P2 simultaneously in the second direction D2 perpendicular to the first direction D1.

The first negative electrode supplier 50n1 may include: a third pickup part P3 that picks up a negative electrode 5n from the negative electrode first direction transporter 40n and supplies the negative electrode 5n to the first stacker 60a; a fourth pickup part P4 that picks up a negative electrode 5n from the negative electrode first direction transporter 40n and moves the negative electrode 5n to the negative electrode bridge 70n; and a second supply driving part F2 that moves the third pickup part P3 and the fourth pickup part P4 simultaneously in the second direction D2 perpendicular to the first direction D1.

The second positive electrode supplier 50p2 and the second negative electrode supplier 50n2 may operate in a similar order. The second positive electrode supplier 50p2 may pick up the positive electrode moved to the positive electrode bridge 70p by the first positive electrode supplier 50p1 and supply the picked-up positive electrode to the second stacker 60b. The second negative electrode supplier 50n2 may pick up the negative electrode moved to the negative electrode bridge 70n by the first negative electrode supplier 50n1 and supply the picked-up negative electrode to the first stacker 60a.

The complex equipment 1 according to an embodiment may further include: a negative electrode floating table 80n spaced above the positive electrode first direction transporter 40p and on which the negative electrode 5n is seated; and a positive electrode floating table 80p spaced above the negative electrode first direction transporter 40n and on which the positive electrode 5p is seated.

The positive electrode floating table 80p is a space for the second positive electrode supplier 50p2 to place the positive electrode 5p. The negative electrode floating table 80n is a space for the second negative electrode supplier 50n2 to place the negative electrode 5n. The positive electrode floating table 80p is positioned above the negative electrode first direction transporter 40n so as not to interfere with the negative electrode first direction transporter 40n from transporting the negative electrode 5n. The negative electrode floating table 80n is positioned above the positive electrode first direction transporter 40p so as not to interfere with the positive electrode first direction transporter 40p from transporting the positive electrode 5p.

The second positive electrode supplier 50p2 may include: a fifth pickup part P5 that picks up a positive electrode 5p on the positive electrode bridge 70p and moves the positive electrode 5p to the positive electrode floating table 80p; a sixth pickup part P6 that picks up the positive electrode 5p on the positive electrode floating table 80p and supplies the picked-up positive electrode 5p to the second stacker 60b; and a third supply driving part F3 that moves the fifth pickup part P5 and the sixth pickup part P6 simultaneously in the second direction D2 perpendicular to the first direction D1.

The second negative electrode supplier 50n2 may include: a seventh pickup part P7 that picks up a negative electrode 5n on the negative electrode bridge 70n and moves the negative electrode 5n to the negative electrode floating table 80n; an eighth pickup part P8 that picks up the negative electrode 5n on the negative electrode floating table 80n and supplies the picked-up negative electrode 5n to the first stacker 60a; and a fourth supply driving part F4 that moves the seventh pickup part P7 and the eighth pickup part P8 simultaneously in the second direction D2 perpendicular to the first direction D1.

The first positive electrode supplier 50p1, the first negative electrode supplier 50n1, the second positive electrode supplier 50p2, and the second negative electrode supplier 50n2 may each include two pickup parts and one supply driving part. The supply driving part may move the two pickup parts simultaneously in the second direction D2. The supply driving part may reciprocally move the two pickup parts in the second direction D2. The two pickup parts may perform a pickup operation or a pickup release operation when moved to one side or the other side in the second direction D2 by the supply driving part. One of the two pickup parts may perform a pickup operation and the other may perform a pickup release operation. Alternatively, the two pickup parts may perform a pickup operation simultaneously or a pickup release operation simultaneously. The four suppliers have the same structure with two pickup parts and one supply driving part each, making it convenient to control multiple suppliers simultaneously and easy to maintain. The positive electrode floating table 80p and the negative electrode floating table 80n may be installed on transporters with different polarities in order to utilize suppliers of the same structure.

Pickup is the action of lifting an electrode on a table or conveyor. Pickup release is the action of putting down an electrode lifted by the pickup part to a designated location. The pickup part may pick up or release an electrode by vacuum suction, gripper, electromagnetic force, adhesive force, etc. The pickup part may be adjusted in length in a third direction D3 perpendicular to the first direction D1 and the second direction D2 to pick up an electrode. The second positive electrode supplier 50p2 and the second negative electrode supplier 50n2 may adjust the length of the pickup part to pick up an electrode on the floating table. The operation of the supply driving part reciprocally moving the pickup part in the second direction D2 and the operation of adjusting the length of the pickup part may be performed using various methods, such as a slider, a motor, a gear, a robotic arm, etc.

The complex equipment may further include: a negative electrode partition 90n located between the positive electrode first direction transporter 40p and the negative electrode floating table 80n, and extending along the path along which the second negative electrode supplier 50n2 moves the negative electrode 5n to prevent negative electrode particles falling from the negative electrode 5n from falling on the positive electrode first direction transporter 40p; and a positive electrode partition 90p located between the negative electrode first direction transporter 40n and the positive electrode floating table 80p, and extending along the path along which the second positive electrode supplier 50p2 moves the positive electrode 5p to prevent positive electrode particles falling from the positive electrode 5p from falling on the negative electrode first direction transporter 40n.

The negative electrode partition 90n may prevent foreign substances such as negative electrode particles falling from the negative electrode 5n during the process of the negative electrode 5n moving above the positive electrode first direction transporter 40p from introducing into the positive electrode first direction transporter 40p. The negative electrode partition 90n may separate the space by being located between the path along which the positive electrode 5p is transported and the path along which the negative electrode 5n is transported.

The negative electrode partition 90n may be formed in a plate shape. The negative electrode partition 90n may be formed to have a greater width than the negative electrode floating table 80n. The negative electrode partition 90n may be formed long along the path along which the second negative electrode supplier 50n2 moves. The negative electrode partition 90n may be positioned between the positive electrode first direction transporter 40p and the negative electrode floating table 80n. The negative electrode partition 90n may be sufficiently spaced apart from the positive electrode first direction transporter 40p so as not to impede the movement of the positive electrode 5p over the positive electrode first direction transporter 40p.

During the process in which the second negative electrode supplier 50n2 picks up and moves the negative electrode 5n, a part of the mixture layer of the negative electrode 5n may be separated and dropped. If a part of the dropped mixture layer contacts the positive electrode 5p or contacts the positive electrode first direction transporter 40p and is mixed with the positive electrode 5p, the function of the electrode assembly 6 may be deteriorated. The negative electrode partition 90n may prevent foreign substances that may be generated during the process in which the second negative electrode supplier 50n2 picks up and moves the negative electrode 5n from coming into contact with the positive electrode 5p.

The positive electrode partition 90p may prevent foreign substances such as positive electrode particles falling from the positive electrode 5p during the process of the positive electrode 5p moving above the negative electrode first direction transporter 40n from introducing into the negative electrode first direction transporter 40n. The positive electrode partition 90p may separate the space by being located between the path along which the positive electrode 5p is transported and the path along which the negative electrode 5n is transported.

The positive electrode partition 90p may be formed in a plate shape. The positive electrode partition 90p may be formed to have a greater width than the positive electrode floating table 80p. The positive electrode partition 90p may be formed long along the path along which the second positive electrode supplier 50p2 moves. The positive electrode partition 90p may be positioned between the negative electrode first direction transporter 40n and the positive electrode floating table 80p. The positive electrode partition 90p may be sufficiently spaced apart from the negative electrode first direction transporter 40n so as not to impede the movement of the negative electrode 5n over the negative electrode first direction transporter 40n.

During the process in which the second positive electrode supplier 50p2 picks up and moves the positive electrode 5p, a part of the mixture layer of the positive electrode 5p may be separated and dropped. If a part of the dropped mixture layer contacts the negative electrode 5n or contacts the negative electrode first direction transporter 40n and is mixed with the negative electrode 5n, the function of the electrode assembly 6 may be deteriorated. The positive electrode partition 90p may prevent foreign substances that may be generated during the process in which the second positive electrode supplier 50p2 picks up and moves the positive electrode 5p from coming into contact with the negative electrode 5n.

The positive electrode bridge 70p may move a positive electrode 5p moved by the first positive electrode supplier 50p1 to a position where the second positive electrode supplier 50p2 picks the positive electrode 5p up, whereas the negative electrode bridge 70n may move a negative electrode 5n moved by the first negative electrode supplier 50n1 to a position where the second negative electrode supplier 50n2 picks the negative electrode 5n up.

The positive electrode bridge 70p and the negative electrode bridge 70n may be implemented in various ways, such as a conveyor belt, LMS, a mechanically reciprocating or rotating plate, etc. The positive electrode bridge 70p may move a positive electrode 5p that the first positive electrode supplier 50p1 has placed on one side of the positive electrode bridge 70p to the other side of the positive electrode bridge 70p. The second positive electrode supplier 50p2 may pick up the positive electrode 5p moved to the other side of the positive electrode bridge 70p. The negative electrode bridge 70n may move a negative electrode 5n that the first negative electrode supplier 50n1 has placed on one side of the negative electrode bridge 70n to the other side of the negative electrode bridge 70n. The second negative electrode supplier 50n2 may pick up the negative electrode 5n moved to the other side of the negative electrode bridge 70n. The positive electrode bridge 70p may move the positive electrode 5p toward the negative electrode first direction transporter 40n, whereas the negative electrode bridge 70n may move the negative electrode 5n toward the positive electrode first direction transporter 40p. That is, the positive electrode bridge 70p and the negative electrode bridge 70n may move the positive electrode 5p or the negative electrode 5n in the second direction D2.

The first positive electrode supplier 50p1, the second positive electrode supplier 50p2, the first negative electrode supplier 50n1, and the second negative electrode supplier 50n2 may supply electrodes to the stackers while repeating the operation performed in the first motion section E1 and the operation performed in the second motion section E2.

The first positive electrode supplier 50p1, the positive electrode bridge 70p, and the second positive electrode supplier 50p2 may be arranged on the same line in the second direction D2, whereas the first negative electrode supplier 50n1, the negative electrode bridge 70n, and the second negative electrode supplier 50n2 may be arranged on the same line in the second direction D2. The positive electrode 5p transported by the positive electrode first direction transporter 40p may be supplied to the second stacker 60b through the negative electrode first direction transporter 40n via the first positive electrode supplier 50p1, the positive electrode bridge 70p, and the second positive electrode supplier 50p2. The negative electrode 5n transported by the negative electrode first direction transporter 40n may be supplied to the first stacker 60a through positive electrode first direction transporter 40p via the first negative electrode supplier 50n1, the negative electrode bridge 70n, and the second negative electrode supplier 50n2.

A plurality of first stackers 60a and the second stackers 60b may be arranged. In FIGS. 1, 2, and 3, the first stacker 60a, the second stacker 60b, the positive electrode second direction transporter 50p, and the negative electrode second direction transporter 50n are disposed one each. In this case, one or more first stackers 60a and second stackers 60b may be disposed in the first direction D1. That is, two or more first stackers 60a may be disposed, and two or more second stackers 60b may be disposed. To supply the positive electrode 5p and the negative electrode 5n to the additionally disposed first stacker 60a and second stacker 60b, the positive electrode second direction transporter 50p and the negative electrode second direction transporter 50n may be additionally disposed.

Only one of the first stacker 60a and the second stacker 60b may be disposed. In this case, to supply the positive electrode 5p and the negative electrode 5n to the additionally disposed first stacker 60a or second stacker 60b, the positive electrode second direction transporter 50p and the negative electrode second direction transporter 50n may be additionally disposed.

The first stacker 60a and the second stacker 60b may be provided as a pair, and one or more pair of first stackers 60a and second stackers 60b may be disposed. The positive electrode second direction transporter 50p and the negative electrode second direction transporter 50n may be provided as a pair, and one or more pair of positive electrode second direction transporters 50p and negative electrode second direction transporters 50n may be disposed.

A pair of positive electrode second direction transporter 50p and negative electrode second direction transporter 50n may supply positive electrodes 5p and negative electrodes 5n to a pair of first stacker 60a and second stacker 60b. In a similar structure, two or more pairs of first stackers 60a and second stackers 60b, and two or more pairs of positive electrode second direction transporter 50p and negative electrode second direction transporter 50n may be disposed for the positive electrode first direction transporter 40p and the negative electrode first direction transporter 40n. The first pair of first stacker 60a and second stacker 60b, and the second pair of first stacker 60a and second stacker 60b may be sequentially arranged in the first direction D1 along the positive electrode first direction transporter 40p and the negative electrode first direction transporter 40n. The first pair of positive electrode second direction transporter 50p and negative electrode second direction transporter 50n, and the second pair of positive electrode second direction transporter 50p and negative electrode second direction transporter 50n may also be sequentially arranged in the first direction D1 along the positive electrode first direction transporter 40p and the negative electrode first direction transporter 40n.

The first pickup part P1 and the second pickup part P2 of the first positive electrode supplier 50p1 may be reciprocally moved in the second direction D2 by the first supply driving part F1 to repeat the set motion in the first motion section E1 and the second motion section E2. The third pickup part P3 and the fourth pickup part P4 of the first negative electrode supplier 50n1 may be reciprocally moved in the second direction D2 by the second supply driving part F2 to repeat the set motion in the first motion section E1 and the second motion section E2.

In the first motion section E1, when the first pickup part P1 of the first positive electrode supplier 50p1 picks up a positive electrode 5p from the positive electrode first direction transporter 40p, at the same time, the second pickup part P2 of the first positive electrode supplier 50p1 releases a positive electrode 5p to the first stacker 60a, whereas when the third pickup part P3 of the first negative electrode supplier 50n1 picks up a negative electrode 5n from the negative electrode first direction transporter 40n, at the same time, the fourth pickup part P4 of the first negative electrode supplier 50n1 releases a negative electrode 5n to the second stacker 60b. In the second motion section E2, when the first pickup part P1 of the first positive electrode supplier 50p1 releases a positive electrode 5p to the positive electrode bridge 70p, at the same time, the second pickup part P2 of the first positive electrode supplier 50p1 picks up a positive electrode 5p from the positive electrode first direction transporter 40p, whereas when the third pickup part P3 of the first negative electrode supplier 50n1 releases a negative electrode 5n to the negative electrode bridge 70n, at the same time, the fourth pickup part P4 of the first negative electrode supplier 50n1 picks up a negative electrode 5n from the negative electrode first direction transporter 40n.

The fifth pickup part P5 and the sixth pickup part P6 of the second positive electrode supplier 50p2 may be reciprocally moved in the second direction D2 by the third supply driving part F3 to repeat the set motion in the first motion section E1 and the second motion section E2. The seventh pickup part P7 and the eighth pickup part P8 of the second negative electrode supplier 50n2 may be reciprocally moved in the second direction D2 by the fourth supply driving part F4 to repeat the set motion in the first motion section E1 and the second motion section E2.

In the first motion section E1, when the fifth pickup part P5 of the second positive electrode supplier 50p2 picks up a positive electrode 5p from the positive electrode bridge 70p, at the same time, the sixth pickup part P6 of the second positive electrode supplier 50p2 may pick up a positive electrode 5p from the positive electrode floating table 80p, whereas when the seventh pickup part P7 of the second negative electrode supplier 50n2 picks up a negative electrode 5n from the negative electrode bridge 70n, at the same time, the eighth pickup part P8 of the second negative electrode supplier 50n2 may pick up a negative electrode 5n from the negative electrode floating table 80n. In the second motion section E2, when the fifth pickup part P5 of the second positive electrode supplier 50p2 releases a positive electrode 5p to the positive electrode floating table 80p, at the same time, the sixth pickup part P6 of the second positive electrode supplier 50p2 may release a positive electrode 5p to the second stacker 60b, whereas when the seventh pickup part P7 of the second negative electrode supplier 50n2 releases a negative electrode 5n to the negative electrode floating table 80n, at the same time, the eighth pickup part P8 of the second negative electrode supplier 50n2 may release a negative electrode 5n to the first stacker 60a.

FIGS. 2, 3, and 11 are referenced. In the first motion section E1, the first supply driving part F1 may move the second pickup part P2 over the positive electrode first direction transporter 40p and move the first pickup part P1 over the positive electrode alignment table 61 of the first stacker 60a. The second pickup part P2 may pick up a positive electrode 5p from the positive electrode first direction transporter 40p. The first pickup part P1 may release a positive electrode 5p onto the positive electrode alignment table 61 of the first stacker 60a. At the same time, in the first motion section E1, the second supply driving part F2 may move the fifth pickup part P5 over the positive electrode bridge 70p and move the sixth pickup part P6 over the positive electrode floating table 80p. The fifth pickup part P5 may pick up a positive electrode 5p from the positive electrode bridge 70p. The sixth pickup part P6 may pick up a positive electrode 5p from the positive electrode floating table 80p.

In the second motion section E2, the first supply driving part F1 may move the second pickup part P2 over the positive electrode bridge 70p and move the first pickup part P1 over the positive electrode first direction transporter 40p. The second pickup part P2 may release a positive electrode 5p onto the positive electrode bridge 70p. The first pickup part P1 may pick up a positive electrode 5p from the positive electrode first direction transporter 40p. At the same time, in the second motion section E2, the second supply driving part F2 may move the fifth pickup part P5 over the positive electrode floating table 80p and move the sixth pickup part P6 over the positive electrode alignment table 61 of the second stacker 60b. The fifth pickup part P5 may release a positive electrode 5p onto the positive electrode floating table 80p. The sixth pickup part P6 may release a positive electrode 5p onto the positive electrode alignment table 61 of the second stacker 60b.

FIGS. 2, 3, and 12 are referenced. In the first motion section E1, the second supply driving part F2 may move the fourth pickup part P4 over the negative electrode first direction transporter 40n and move the third pickup part P3 over the negative electrode alignment table 62 of the second stacker 60b. The fourth pickup part P4 may pick up a negative electrode 5n from the negative electrode first direction transporter 40n. The third pickup part P3 may release a negative electrode 5n onto the negative electrode alignment table 62 of the second stacker 60b. At the same time, in the first motion section E1, the fourth supply driving part F4 may move the seventh pickup part P7 over the negative electrode bridge 70n and move the eighth pickup part P8 over the negative electrode floating table 80n. The seventh pickup part P7 may pick up a negative electrode 5n from the negative electrode bridge 70n. The eighth pickup part P8 may pick up a negative electrode 5n from the negative electrode floating table 80n.

In the second motion section E2, the second supply driving part F2 may move the fourth pickup part P4 over the negative electrode bridge 70n and move third pickup part P3 over the negative electrode first direction transporter 40n. The fourth pickup part P4 may release a negative electrode 5n onto the negative electrode bridge 70n. The third pickup part P3 may pick up a negative electrode 5n from the negative electrode first direction transporter 40n. At the same time, in the second motion section E2, the fourth supply driving part F4 may move the seventh pickup part P7 over the negative electrode floating table 80n and move the eighth pickup part P8 over the negative electrode alignment table 62 of the first stacker 60a. The seventh pickup part P7 may release a negative electrode 5n onto the negative electrode floating table 80n. The eighth pickup part P8 may release a negative electrode 5n onto the negative electrode alignment table 62 of the first stacker 60a.

The speed at which the positive electrode first direction transporter 40p and the negative electrode first direction transporter 40n transport the positive electrodes 5p and the negative electrodes 5n may be determined according to the cycle in which the first motion section E1 and the second motion section E2 are repeated.

When the operation of the suppliers is repeated in the first motion section E1 and the second motion section E2 described, the positive electrodes 5p and the negative electrodes 5n may be supplied to the stackers. The stackers may also manufacture the electrode assemblies 6 by repeating the order of the first stacking section G1 and the second stacking section G2 to match the first motion section E1 and the second motion section E2.

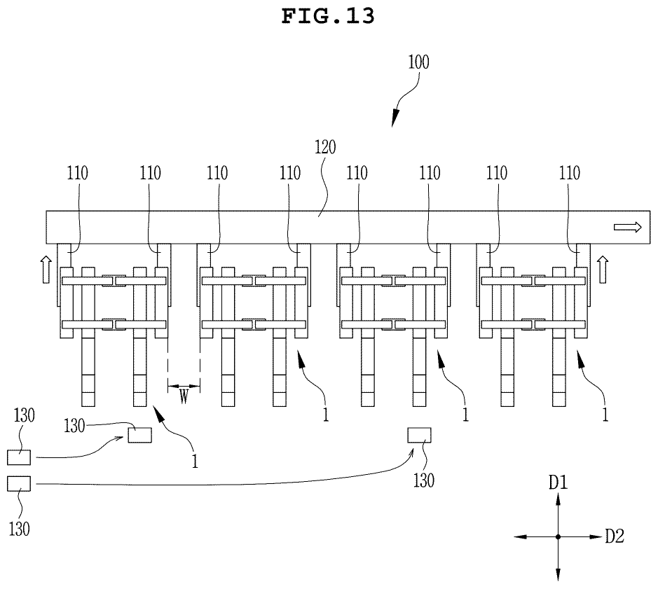

FIG. 13 is a view showing an equipment layout 100 according to an embodiment.

The equipment layout 100 according to an embodiment is a structure in which composite equipment 1 including an unwinder 20p or 20n, a roll replacement device 10p or 10n, a notching machine 31p or 31n, a dryer 33p or 33n, a cutter 32p or 32n, a first direction transporter 40p or 40n, a second direction transporter 50p or 50n, a stacker 60a or 60b, etc., are arranged in a secondary battery manufacturing plant.

The equipment layout 100 according to an embodiment may include: plurality of composite equipment 1 described with reference to FIGS. 1 to 9; a plurality of first carriers 110 that transports an electrode assembly 6 manufactured by the first stacker 60a and the second stacker 60b of the composite equipment 1 in the first direction D1; and a second carrier 120 that receives an electrode assembly 6 transported by the plurality of first carriers 110 and transports the electrode assembly 6 in the second direction D2.

The composite equipment 1 is a device in which a variety of devices (e.g., a roll replacement device 10p or 10n, an unwinder 20p or 20n, a notching machine 31p or 31n, a dryer 33p or 33n, a cutter 32p or 32n, a first direction transporter 40p or 40n, a second direction transporter 50p or 50n, a stacker 60a or 60b) necessary for manufacturing an electrode assembly 6 are arranged such that the devices may operated in a single flow. The composite equipment 1 is designed such that multiple various devices occupy a minimum area.

The first carrier 110 may transport electrode assemblies 6 manufactured by the composite equipment 1. The second carrier 120 may transport the electrode assemblies 6 received from the first carriers 110. The first carrier 110 and the second carrier 120 may be implemented as conveyor belts, LMS, and various other transport devices. The first carrier 110 may be disposed in the first direction D1. One first carrier 110 may be disposed in the first stacker 60a and one first carrier 110 may be disposed in the second stacker 60b. That is, two first carriers 110 may be disposed in one piece of composite equipment 1. The first carriers 110 may receive an electrode assembly 6 manufactured in the stackers of the composite equipment 1 and transport the electrode assembly 6 to the second carrier 120. The second carrier 120 may receive the electrode assembly 6 from the first carriers 110 and transport the received electrode assembly 6. The second carrier 120 may be disposed in the second direction D2.

The plurality of composite equipment 1 may be arranged such that the first carriers 110 are connected toward the second carrier 120. The plurality of composite equipment 1 may be arranged such that the stackers 60a and 60b are close to the second carrier 120 and the unwinders are far from the second carrier 120. The plurality of composite equipment 1 may be arranged so as to be spaced apart from each other by a set interval W. That is, the plurality of composite equipment 1 may be arranged like comb teeth extending from the second carrier 120 to one side. Furthermore, the plurality of composite equipment 1 may be arranged like comb teeth extending from the second carrier 120 to both sides. In this case, the electrode assemblies 6 manufactured from both sides may be output toward the second carrier 120.

The plurality of composite equipment 1 may be arranged to be spaced apart in the second direction D2. The plurality of composite equipment 1 may be arranged to be spaced apart at the set interval W along the second carrier 120 extending in the second direction D2. The interval W between the plurality of composite equipment 1 may be determined to be a spacing that allows a worker to enter between the stackers and perform necessary work. The worker may enter the space between the plurality of composite equipment 1. The worker may enter in the first direction D1 to have access to the roll replacement device 10p or 10n, the unwinder 20p or 20n, the notching machine 31p or 31n, the dryer 33p or 33n, the cutter 32p or 32n, the first direction transporter 40p or 40n, the second direction transporter 50p or 50n, the stacker 60a or 60b, and the first carriers 110. This is because the composite equipment 1 has multiple devices arranged in the first direction D1. In the electrode assembly 6 manufacturing process, all materials and workers are able to move in the first direction D1, and the manufactured electrode assembly 6 moves in the second direction D2, and thus the plant's movement line may be simplified.

The equipment layout 100 according to an embodiment may further include: a self-moving roll transport unit 130 that transports a positive electrode sheet roll 2p or a negative electrode sheet roll 2n to the plurality of composite equipment 1. The roll transport unit 130 may move while loading the positive electrode sheet roll 2p or the negative electrode sheet roll 2n and supply the roll to the positive electrode roll replacement device 10p or the negative electrode roll replacement device 10n. Since the positive electrode roll replacement device 10p and the negative electrode roll replacement device in are positioned in a parallel manner on one side in the equipment layout 100, the route for the roll transport unit 130 to approach the roll replacement devices 10p and 10n may be simplified. Since it takes time for the composite equipment 1 to exhaust the rolls, one roll transport unit 130 can supply rolls to the plurality of composite equipment 1. In addition, since the route for the roll transport unit 130 to reach the plurality of composite equipment 1 is simple, the travel time may be minimized. Thus, in the equipment layout 100, the number of roll transport units 130 may be relatively small compared to the number of the plurality of composite equipment 1. As a result, the space occupied by the roll transport unit 130 inside the plant and the space required for the roll transport unit 130 to move may be minimized.

The above disclosure has been described in detail through specific embodiments. The contents described above are merely examples of applying the principles of the present disclosure, and other configurations may be further included without departing from the scope of the present disclosure.

What is claimed is:

1. Complex equipment comprising:
a positive electrode manufacturing machine configured to form a positive electrode by creating a tab on a positive electrode sheet running in a first direction, and drying and cutting the sheet;
a negative electrode manufacturing machine configured to form a negative electrode by creating a tab on a negative electrode sheet running in the first direction, and drying cutting the sheet, and placed parallel to the positive electrode manufacturing machine;
a positive electrode first direction transporter configured to transport the positive electrode output from the positive electrode manufacturing machine in the first direction;
a negative electrode first direction transporter configured to transport the negative electrode output from the negative electrode manufacturing machine in the first direction;
at least one first stacker positioned on an opposite side of the negative electrode first direction transporter with the positive electrode first direction transporter at a center, and configured to form an electrode assembly by stacking the positive electrode, a separator, and the negative electrode;
at least one second stacker positioned on an opposite side of the positive electrode first direction transporter with the negative electrode first direction transporter at a center, and configured to form an electrode assembly by stacking the positive electrode, a separator, and the negative electrode;
at least one positive electrode second direction transporter configured to transport a positive electrode transported on the positive electrode first direction transporter in a second direction and supply the positive electrode to the at least one first stacker and the at least one second stacker; and
at least one negative electrode second direction transporter configured to transport a negative electrode transported on the negative electrode first direction transporter in the second direction and supply the negative electrode to the at least one first stacker and the at least one second stacker.

2. The equipment of claim 1, wherein the positive electrode manufacturing machine comprises:
a positive electrode notching machine configured to form a tab on a positive electrode sheet running in the first direction;
a positive electrode dryer configured to dry the positive electrode sheet on which the tab is formed; and
a positive electrode cutter configured to cut the dried positive electrode sheet to create a positive electrode, and
the negative electrode manufacturing machine comprises:
a negative electrode notching machine configured to form a tab on a negative electrode sheet running in the first direction;
a negative electrode dryer configured to dry the negative electrode sheet on which the tab is formed; and
a negative electrode cutter configured to cut the dried negative electrode sheet to create a negative electrode.

3. The equipment of claim 1, wherein the positive electrode manufacturing machine comprises:
a positive electrode dryer configured to dry a positive electrode sheet running in the first direction;
a positive electrode notching machine configured to form a tab on the dried positive electrode sheet; and
a positive electrode cutter configured to cut the positive electrode sheet on which the tab is formed to create a positive electrode, and
the negative electrode manufacturing machine comprises:
a negative electrode dryer configured to dry a negative electrode sheet running in the first direction;
a negative electrode notching machine configured to form a tab on the dried negative electrode sheet; and
a negative electrode cutter configured to cut the negative electrode sheet on which the tab is formed to create a negative electrode.

4. The equipment of claim 1, further comprising:
a positive electrode unwinder configured to unwind a positive electrode sheet roll in the first direction and supply the positive electrode sheet to the positive electrode manufacturing machine; and
a negative electrode unwinder configured to unwind a negative electrode sheet roll in the first direction and supply the negative electrode sheet to the negative electrode manufacturing machine.

5. The equipment of claim 4, further comprising:
a positive electrode roll replacement device configured to discharge an exhausted positive electrode sheet roll and replaces the exhausted positive electrode sheet roll with a prepared new positive electrode sheet roll when a positive electrode sheet roll of the positive electrode unwinder is exhausted; and
a negative electrode roll replacement device configured to discharge an exhausted negative electrode sheet roll and replaces the exhausted negative electrode sheet roll with a prepared new negative electrode sheet roll when a negative electrode sheet roll of the negative electrode unwinder is exhausted.

6. The equipment of claim 1, wherein the positive electrode second direction transporter comprises:
a positive electrode bridge located between the positive electrode first direction transporter and the negative electrode first direction transporter, and on which the positive electrode is seated;
a first positive electrode supplier configured to supply a positive electrode on the positive electrode first direction transporter to the at least one first stacker, and move another positive electrode on the positive electrode first direction transporter to the positive electrode bridge; and
a second positive electrode supplier configured to supply the positive electrode on the positive electrode bridge to the at least one second stacker, and
the negative electrode second direction transporter comprises:
a negative electrode bridge located between the positive electrode first direction transporter and the negative electrode first direction transporter, and on which the negative electrode is seated;
a first negative electrode supplier configured to supply a negative electrode on the negative electrode first direction transporter to the at least one second stacker, and move another negative electrode on the negative electrode first direction transporter to the negative electrode bridge; and
a second negative electrode supplier configured to supply the negative electrode on the negative electrode bridge to the at least one first stacker.

7. The equipment of claim 6, wherein the first positive electrode supplier comprises:
a first pickup part configured to pick up a positive electrode from the positive electrode first direction transporter and supply the positive electrode to the at least one first stacker;
a second pickup part configured to pick up a positive electrode from the positive electrode first direction transporter and move the positive electrode to the positive electrode bridge; and
a first supply driving part configured to move the first pickup part and the second pickup part simultaneously in the second direction perpendicular to the first direction, and
the first negative electrode supplier comprises:
a third pickup part configured to pick up a negative electrode from the negative electrode first direction transporter and supply the negative electrode to the at least one first stacker;
a fourth pickup part configured to pick up a negative electrode from the negative electrode first direction transporter and move the negative electrode to the negative electrode bridge; and
a second supply driving part configured to move the third pickup part and the fourth pickup part simultaneously in the second direction perpendicular to the first direction.

8. The equipment of claim 6, further comprising:
a negative electrode floating table spaced above the positive electrode first direction transporter and on which the negative electrode is seated; and
a positive electrode floating table spaced above the negative electrode first direction transporter and on which the positive electrode is seated,
wherein the second positive electrode supplier comprises:
a fifth pickup part configured to pick up a positive electrode from the positive electrode bridge and move the positive electrode to the positive electrode floating table;
a sixth pickup part configured to pick up the positive electrode from the positive electrode floating table and supply the picked-up positive electrode to the at least one second stacker; and
a third supply driving part configured to move the fifth pickup part and the sixth pickup part simultaneously in the second direction perpendicular to the first direction, and
the second negative electrode supplier comprises:
a seventh pickup part configured to pick up a negative electrode from the negative electrode bridge and move the negative electrode to the negative electrode floating table;
an eighth pickup part configured to pick up the negative electrode from the negative electrode floating table and supply the picked-up negative electrode to the at least one first stacker; and
a fourth supply driving part configured to move the seventh pickup part and the eighth pickup part simultaneously in the second direction perpendicular to the first direction.

9. The equipment of claim 8, further comprising:
a negative electrode partition located between the positive electrode first direction transporter and the negative electrode floating table, and configured to extend along a path along which the second negative electrode supplier moves the negative electrode to prevent negative electrode particles falling from the negative electrode from falling on the positive electrode first direction transporter; and
a positive electrode partition located between the negative electrode first direction transporter and the positive electrode floating table, and configured to extend along a path along which the second positive electrode supplier moves the positive electrode to prevent positive electrode particles falling from the positive electrode from falling on the negative electrode first direction transporter.

10. The equipment of claim 6, wherein the positive electrode bridge moves a positive electrode moved by the first positive electrode supplier to a position where the positive electrode is picked up by the second positive electrode supplier, and
the negative electrode bridge moves a negative electrode moved by the first negative electrode supplier to a position where the negative electrode is picked up by the second negative electrode supplier.

11. The equipment of claim 7, wherein the first pickup part and the second pickup part of the first positive electrode supplier are reciprocally moved in the second direction by the first supply driving part to repeat a set motion in a first motion section and a second motion section, and
the third pickup part and the fourth pickup part of the first negative electrode supplier are reciprocally moved in the second direction by the second supply driving part to repeat a set motion in the first motion section and the second motion section,
wherein in the first motion section, when the first pickup part of the first positive electrode supplier picks up a positive electrode from the positive electrode first direction transporter, at the same time, the second pickup part of the first positive electrode supplier releases a positive electrode to the at least one first stacker, whereas when the third pickup part of the first negative electrode supplier picks up a negative electrode from the negative electrode first direction transporter, at the same time, the fourth pickup part of the first negative electrode supplier releases a negative electrode to the at least one second stacker, and
in the second motion section, when the first pickup part of the first positive electrode supplier releases a positive electrode to the positive electrode bridge, at the same time, the second pickup part of the first positive electrode supplier picks up a positive electrode from the positive electrode first direction transporter, whereas when the third pickup part of the first negative electrode supplier releases a negative electrode to the negative electrode bridge, at the same time, the fourth pickup part of the first negative electrode supplier picks up a negative electrode from the negative electrode first direction transporter.

12. The equipment of claim 8, wherein the fifth pickup part and the sixth pickup part of the second positive electrode supplier are reciprocally moved in the second direction by the third supply driving part to repeat a set motion in a first motion section and a second motion section, and
the seventh pickup part and the eighth pickup part of the second negative electrode supplier are reciprocally moved in the second direction by the fourth supply driving part to repeat a set motion in the first motion section and the second motion section,
wherein in the first motion section, when the fifth pickup part of the second positive electrode supplier picks up a positive electrode from the positive electrode bridge, at the same time, the sixth pickup part of the second positive electrode supplier picks up a positive electrode from the positive electrode floating table, whereas when the seventh pickup part of the second negative electrode supplier picks up a negative electrode from the negative electrode bridge, at the same time, the eighth pickup part of the second negative electrode supplier picks up a negative electrode from the negative electrode floating table, and
in the second motion section, when the fifth pickup part of the second positive electrode supplier releases a positive electrode to the positive electrode floating table, at the same time, the sixth pickup part of the second positive electrode supplier releases a positive electrode to the at least one second stacker, whereas when the seventh pickup part of the second negative electrode supplier releases a negative electrode to the negative electrode floating table, at the same time, the eighth pickup part of the second negative electrode supplier releases a negative electrode to the at least one first stacker.

13. The equipment of claim 6, wherein the first positive electrode supplier, the positive electrode bridge, and the second positive electrode supplier are arranged on the same line in the second direction, and
the first negative electrode supplier, the negative electrode bridge, and the second negative electrode supplier are arranged on the same line in the second direction.

14. An equipment layout comprising:
the complex equipment including a plurality of complex equipment according to claim 1;
a plurality of first carriers configured to transport an electrode assembly manufactured by a first stacker and a second stacker of the plurality of composite equipment in a first direction; and
a second carrier configured to receive an electrode assembly transported by the plurality of first carriers and transport the electrode assembly in a second direction.

15. The layout of claim 14, wherein the plurality of composite equipment are arranged at set intervals along the second carrier extending in the second direction.

16. The layout of claim 14, further comprising:
a self-moving roll transport unit configured to transport a positive electrode sheet roll or a negative electrode sheet roll to the plurality of composite equipment.
